(19) United States
(12) Patent Application Publication
(10) Pub. No.: US 2020/0211316 A1
(43) Pub. Date: Jul. 2, 2020

(54) BACCARAT TABLE SYSTEM

(71) Applicant: cyberJ Co., Ltd., Tokyo (JP)

(72) Inventor: Takayuki SAGA, Tokyo (JP)

(21) Appl. No.: 16/812,403

(22) Filed: Mar. 9, 2020

Related U.S. Application Data
(63) Continuation of application No. PCT/JP2018/043940, filed on Nov. 29, 2018.

(30) Foreign Application Priority Data
Dec. 4, 2017 (JP) 2017-232386

(51) Int. Cl. G07F 17/32

(52) U.S. Cl. CPC G07F 17/322; G07F 17/3288; G07F 17/323; G07F 17/3248; G07F 17/3211; G07F 17/3293

(57) ABSTRACT

A baccarat table system includes a table presenting on its upper surface a competition progression area and a chip bet area, and includes a card type output unit configured to output a type of a card dealt by a dealer; a bet display unit arranged to present a display screen on the upper surface of the table and configured to display the chip bet area for each of game participants in a projected image; and a bet area display control unit configured to sequentially change a display state of the chip bet area in the bet display unit responsive to a deal state of cards based on the output from the card type output unit.

The contents of the following Japanese patent applications are incorporated herein by reference:

No. 2017-232386 filed in JP on Dec. 4, 2017, and

No. PCT/JP2018/043940 filed on Nov. 29, 2018.

### BACKGROUND

### 1. Technical Field

The present invention relates to table systems intended to use for baccarat.

### 2. Related Art

Patent document 1 describes a play game table system including: a play game table having a plurality of bet areas for respective players, each having arranged therein a game medium the player bets and an antenna unit configured to read out monetary value of the game medium arranged in each of the plurality of bet areas by radio communication; a control unit configured to perform scan processing that controls the antenna unit to obtain a sum of the monetary values equivalent to the game media in the bet areas; and a display configured to display the sum of the monetary values for each of the plurality of bet areas and having a touch panel capable of designating any of the plurality of bet areas, characterized in that when any of the plurality of bet areas is designated through the touch panel of the display, the control unit again performs the scan processing on that bet area.

Patent document 2 describes a play game assist system for a baccarat game including: an input device for inputting outcome data of a baccarat game in association with an occurrence order; and a display device for displaying the series of outcome data input in association with the occurrence order in a form of a score table.

Furthermore, patent document 3 describes a game device for a baccarat game or the like, where when receiving selection design information from a management server, a game control unit causes a game display unit to display a single design suggestion image which suggests the content of one unrevealed card in advance, and then causes the game display unit to display all the playing cards that are of a player side and a banker side and that correspond to the selection design information.

### RELATED ART DOCUMENT

### Patent Document

[Patent document 1] Patent No. 6085338

[Patent document 2] Japanese Patent Application Publication No. 2003-220169

[Patent document 3] Japanese Patent Application Publication No. 2017-123979

### GENERAL DISCLOSURE

However, techniques described in patent documents 1 to 3 cannot reduce the burden on the dealer sufficiently. In addition, the technique described in patent document 3 does not allow game participants to have direct visual and physical contacts with cards; thus it is impossible for the game participants to perform the “squeeze” of a card and enjoy the best part of baccarat.

According to one aspect of the present invention, a baccarat table system is provided, which includes a table presenting on an upper surface thereof a competition progression area in which a dealer deals cards to progress a competition between two imaginary persons and a chip bet area having a plurality of bet spots set for each of game participants and set up in association with types of expectations about the competition between the two persons, the game participants betting chips on the plurality of bet spots based on expectations of the game participants, where the system includes: a card type output unit configured to output a type of a card dealt by a dealer; a bet display unit arranged to present a display screen on the upper surface of the table and configured to display the chip bet area for each of the game participants in a projected image; a bet area display control unit configured to sequentially change a display state of the chip bet area in the bet display unit responsive to a deal state of cards based on the output from the card type output unit; a competition history output unit configured to output a history of the competition based on the output from the card type output unit; and a chronological record storing unit configured to store histories output by the competition history output unit chronologically and in a manner manageable in a ledger, where the system is characterized in that the bet area display control unit can change a quantity and types of bet spots for expectations.

According to one aspect of the present invention, a competition progression area in which a dealer deals cards to progress a competition between two imaginary persons and a chip bet area having a plurality of bet spots set for each of game participants and set up in association with types of expectations about the competition between the two persons, the game participants betting chips on the plurality of bet spots based on expectations of the game participants, are presented on an upper surface of a table, a card type output unit outputs a type of a card dealt by the dealer, a bet display unit is arranged to present a display screen on the upper surface of the table and configured to display the chip bet area for each of the game participants in a projected image, and a bet area display control unit sequentially changes a display state of the chip bet area in the bet display unit responsive to a deal state of cards.

Therefore, the play participants can bet chips on the bet spots in the chip bet areas displayed on the table and observe on site the dealer actually dealing cards to run the competition between the two imaginary persons, allowing the game participants to enjoy the best part of baccarat such as card handling by the dealer and squeeze of a card. Further, in this situation, a display state of the chip bet areas are changed responsive to the state of a game as the game progresses, so that the dealer and the game participants can easily grasp the state of bet chips, and particularly the burden on the dealer is reduced and the processing of the game can be performed in a prompt and correct manner.

In addition, according to one aspect of the present invention, a competition history output unit outputs a history of the competition based on the output from the card type output unit, and a chronological record storing unit stores histories output by the competition history output unit chronologically and in the manner manageable in a ledger. Also, the bet area display control unit can change the quantity and the types of bet spots for expectations. Accordingly, the histories of competitions can be chronologically managed in a ledger, and particularly, even if types of betting increases to a large number due to change in the quantity and the types of bet spots by the bet area display control unit, the histories of the baccarat table system can be easily managed in a ledger. Further, the bet area display control unit can create bet spots for expectations, so that any prediction can be displayed as a bet spot in the chip bet area for operation. Accordingly, it is possible to draw the interest of the game participants by adding novel expectations not seen in conventional baccarat rules.

According to one aspect of the present invention, a baccarat table system is provided, which includes a table presenting on an upper surface thereof a competition progression area in which a dealer deals cards to progress a competition between two imaginary persons and a chip bet area having a plurality of bet spots set for each of game participants and set up in association with types of expectations about the competition between the two persons, the game participants betting chips on the plurality of bet spots based on expectations of the game participants, where the system includes: a card type output unit configured to output a type of a card dealt by a dealer; a bet display unit arranged to present a display screen on the upper surface of the table and configured to display the chip bet area for each of the game participants in a projected image; a bet area display control unit configured to change a display state of the chip bet area in the bet display unit responsive to a deal state of cards based on the output from the card type output unit; a bet designating unit arranged for each of the game participants and configured to designate a chip amount and a bet spot on which chips are bet according to an instruction from that game participant; a chip image display unit configured to display, in the designated bet spot in the chip bet area as a bet state, a chip image representing a chip bet in the bet display unit according to an instruction from the bet designating unit; a settling unit configured to settle bet chips based on an outcome of the competition; a competition history output unit configured to output a history of the competition based on the output from the card type output unit; a chronological record storing unit configured to store histories output by the competition history output unit chronologically and in a manner manageable in a ledger, where the system is characterized in that the bet area display control unit can change the quantity and types of bet spots for expectations.

According to one aspect of the present invention, a competition progression area in which a dealer deals cards to progress a competition between two imaginary persons and a chip bet area having a plurality of bet spots set for each of game participants and set up in association with types of expectations about the competition between the two persons, the game participants betting chips on the plurality of bet spots based on expectations of the game participants, are presented on an upper surface of a table, a card type output unit outputs a type of a card dealt by the dealer, a bet display unit is arranged to present a display screen on the upper surface of the table and configured to display the chip bet area for each of the game participants in a projected image, and a bet area display control unit changes a display state of the chip bet area in the bet display unit responsive to a deal state of cards.

Further, the game participants designate, using a bet designating unit arranged for each of the game participants, a chip amount and a bet spot on which chips are bet according to an instruction from that game participant, a chip image display unit displays, in the designated bet spot in the chip bet area as a bet state, a chip image representing a chip bet through the bet display unit according to an instruction from the bet designating unit, and in addition, a settling unit settles bet chips based on an outcome of the competition.

Therefore, the play participants can bet, through the bet designating unit, chip images on the bet spots in the chip bet areas displayed on the table and observe on site the dealer actually dealing cards to run the competition between the imaginary two persons. Accordingly, the game participants can enjoy the best part of baccarat such as card handling by the dealer and squeeze of a card. Also, the settlement processing is performed on the chips based on the outcome of the competition, so that the dealer does not need to handle the chips, and moreover the game participants can easily grasp how the bet chips have been processed. Accordingly, the burden on the dealer is reduced, games can be processed in a prompt and correct manner, and misconduct does not occur.

In addition, according to one aspect of the present invention, a competition history output unit outputs a history of the competition based on the output from the card type output unit, and a chronological record storing unit stores histories output by the competition history output unit chronologically and in a manner manageable in a ledger. Also, the bet area display control unit can change a quantity and types of bet spot for expectations. Therefore, the histories of competitions can be chronologically managed in a ledger, and particularly, even if types of betting increases to a large number due to change in the quantity and the types of bet spots by the bet area display control unit, the histories of the baccarat table system can be easily managed in a ledger. Further, the bet area display control unit can create bet spots for expectations, so that any prediction can be displayed as a bet spot in the chip bet area for operation. Accordingly, it is possible to draw the interest of the game participants by adding novel expectations not seen in conventional baccarat rules.

According to one aspect of the present invention, the system is characterized in that the bet display unit is arranged to present a display screen on the upper surface of the table, and displays on each of one or more display devices the chip bet area for each of the game participants in a projected image with the chip bet areas displayed separately in association with the respective game participants. According to one aspect of the present invention, it is possible to display a number of chip bet areas on a single display device.

According to one aspect of the present invention, the system is characterized in that it includes an announcement display configured to display statistic data including at least one of: data pertaining to a bet state and a hit or miss state of chips and a cumulative total of won chips in each game for each of the game participants; data in terms of current and previous shoes, previous dates and previous months that is aggregated for the table; and data pertaining to hitting rates and the maximum points won at a single betting for the game participants.

According to one aspect of the present invention, an announcement display can display statistic data including at least one of: data pertaining to a bet state and a hit or miss state of chips and a cumulative total of won chips in each game for each of the game participants; data in terms of current and previous shoes, previous dates and previous months that is aggregated for the table; and data pertaining to hitting rates and the maximum points won at a single betting for the game participants. Therefore, each game participant can confirm the bet states of the other game participants.

According to one aspect of the present invention, the system is characterized in that it includes a dealer display unit for the dealer to see, and a card deal instruction control unit configured to cause the dealer display unit to display an instruction on dealing of cards based on the output of the card type output unit and according to a baccarat rule.

According to one aspect of the present invention, the instruction on dealing of cards according to the baccarat rule that is issued from the card deal instruction control unit is displayed on the dealer display which can be seen by the dealer.

Therefore, the dealer can deal cards in a correct and prompt manner, and the burden is reduced.

According to one aspect of the present invention, the baccarat table system is characterized in that it includes a ruled line display unit configured to display a ruled line which is a history of the competition based on the history output by the competition history output unit.

According to one aspect of the present invention, a ruled line display unit displays the ruled line which is the history of the competition based on the output history.

Therefore, the dealer does not need to record a history to create the ruled lines, so that the burden is reduced, and moreover, the ruled lines are displayed on the ruled line display unit, so that the game participant and those interested in the game can obtain information about previous competitions.

According to one aspect of the present invention, the system includes a bet condition setting unit configured to set an allowable upper limit amount for betting and odds for each of the bet spots, and is characterized in that the bet display unit displays the upper limit amount and the hitting odds.

According to one aspect of the present invention, a bet condition setting unit sets the allowable upper limit amount for betting and the hitting odds for each of the bet spots, and the bet display unit displays the upper limit amount and the hitting odds.

Therefore, each of the game participants can obtain information about the bet and bet according to the convenience of that game participant.

According to one aspect of the of the present invention, the system is characterized in that after a period of time during which betting is permitted elapses, the bet area display control unit displays, on the chip bet area, a representation indicating that the period of time during which betting is permitted elapsed.

According to one aspect of the present invention, after a period of time during which betting is permitted elapses, the bet area display control unit displays, on the chip bet area, a representation indicating that the period of time during which betting is permitted elapsed, for example, it displays the chip bet area in black. Therefore, the game participants recognize whether or not betting is permitted at a glance, and the dealer can easily manage the close of betting, resulting in reduction in the burden on the dealer.

According to one aspect of the present invention, the system is characterized in that the bet area display control unit displays, on bet spots that no longer have a possibility of being right during a progression of the competition, a representation indicating that the bet spots no longer have the possibility of being right. According to one aspect of the present invention, the bet area display control unit displays, on the bet spots that no longer have a possibility of being right during the progression of the competition, the representation indicating that the bet spots no longer have the possibility of being right, for example displays in black or marks with X those bet spots. Therefore, the game participants can recognize the current states of their bets at a glance, and get more interested in the game.

According to one aspect of the present invention, the system is characterized in that the bet area display control unit displays, on those of the bet spots that have been determined to be right during the progression of the competition, a representation indicating that those bet spots have been determined to be right.

According to one aspect of the present invention, the bet area display control unit displays, on those of the bet spots that have been determined to be right during the progression of the competition, the representation indicating that those bet spots have been determined to be right during the progression of the competition or a brighter or blinking representation. Therefore, the game participants are highly aware that their bets are right and grow elation, so that they get more and more interested in the game.

According to one aspect of the present invention, the system is characterized in that it includes a bet amount adjusting unit configured to adjust bet amounts of all the game participants at a certain ratio when a difference between bet amount totals bet respectively on a player and a banker that depends on the aggregate total of bet amounts by the game participants and that is calculated based on bet states of all bet spots for the game participants exceeds a predetermined value set in advance, so that this difference does not go beyond the predetermined value.

According to one aspect of the present invention, a bet amount adjusting unit calculates, based on bet states of all the bet spots for all the game participants, a difference between bet amount totals bet respectively on a player and a banker that depends on the aggregate total of bet amounts by the game participants, and if the difference exceeds a value set in advance, adjusts bet amounts of all the game participants at a certain ratio, so that the difference does not go beyond the value.

Therefore, the difference being equal to or larger than a certain value can be prevented, where the difference is a difference between bet amount totals bet respectively on a player and a banker for a game.

According to one aspect of the present invention, the system is characterized in that it includes, on the table, a card travelling area for giving a card to the game participants between the chip bet areas.

According to one aspect of the present invention, the card travelling area for giving a card to the game participants is provided between the chip bet areas on the table.

Therefore, when the dealer gives a card to a game participant for the game participant to perform the squeeze, the card to be given does not enter the chip bet areas, which can prevent the card from contacting chips that have been bet or making the chips untidy.

According to one aspect of the present invention, the system is characterized in that the bet area display control unit can create bet spots for expectations.

According to one aspect of the present invention, the bet area display control unit can create the bet spots for expectations.

Therefore, any prediction can be displayed as a bet spot in the chip bet area for operation, and the game participants can select a bet spot for expectation according to their respective preferences at their respective seats. Accordingly, it is possible to draw the interest of the game participants by adding novel expectations not seen in conventional baccarat rules, and further it is possible for each of the game participants to set bet spots which draw the interest of that game participant on the bet area of that game participant, enabling easier betting.

According to one aspect of the present invention, the system is characterized in that it includes: a data accumulation unit configured to accumulate statistic data including at least one of: data pertaining to a bet state and a hit or miss state of chips and a cumulative total of won chips in each game for the game participants; data in terms of current and previous shoes, previous dates and previous months that is aggregated for the table; and data pertaining to hitting rates and the maximum points won at a single betting for the game participants; a visualized data generating unit configured to output, as a visualized representation data, designated data from the data accumulated in the data accumulation unit; and an information display unit configured to display an image based on the visualized representation data.

According to one aspect of the present invention, a data accumulation unit accumulates statistic data including at least one of: data pertaining to a bet state and a hit or miss state of chips and a cumulative total of won chips in each game for the game participants; data in terms of current and previous shoes, previous dates and previous months that is aggregated for the table; and data pertaining to hitting rates and the maximum points won at a single betting for the game participants, and a visualized data generating unit outputs designated data as a visualized representation data; and an information display unit displays an image based on the visualized representation data.

Therefore, the game participants and customers around the table can visually recognize the information display unit to grasp a bet state and a hit or miss state of chips and a cumulative total of won chips in each game for the game participants, states in terms of current and previous shoes, previous dates and previous months that are aggregated for the table and hitting rates and the maximum points won at a single betting for the game participants, and the game participants and other customers develop much more interest in the game.

According to one aspect of the present invention, the system is characterized in that when a bet amount limit is exceeded in any of the bet spots, the bet area display control unit prohibits betting on that bet spot, and after a period of time during which betting is permitted elapses, the bet area display control unit prohibits further betting on the chip bet area.

According to one aspect of the present invention, when a bet amount limit is exceeded in any of the bet spots, the bet area display control unit prohibits betting on that bet spot, and after a period of time during which betting is permitted elapses, the bet area display control unit prohibits further betting on the chip bet area.

Therefore, betting with a bet amount exceeding the bet amount limit and betting after the elapse of bet time are prevented, so that progression of the game in a smooth and fair manner can be achieved.

### BRIEF DESCRIPTION OF THE DRAWINGS

FIG. 1 is a flowchart showing in outline a flow of a casino game using a baccarat table system according to an embodiment.

FIG. 2 is a schematic view showing an arrangement state of the baccarat table system according to a first embodiment.

FIG. 3 is a block diagram showing a configuration of the baccarat table system according to the first embodiment.

FIG. 4 is a flowchart showing processing of the baccarat table system according to the first embodiment.

FIG. 5 is a diagram showing one example of a chip bet area displayed in the initial state on a bet display of the baccarat table system according to the first embodiment.

FIG. 6 is a diagram showing one example of a representation on a dealer display of the baccarat table system according to the first embodiment.

FIG. 7 is a diagram showing one example of the chip bet area displayed at the time of a game reaching a settlement on the bet display of the baccarat table system according to the first embodiment.

FIG. 8 is a diagram showing one example of a representation on a ruled line display of the baccarat table system according to the first embodiment.

FIG. 9 is a diagram showing one example of a history stored by a history storing unit of the baccarat table system according to the first embodiment.

FIG. 10 is a schematic view showing an arrangement state of a baccarat table system according to a second embodiment.

FIG. 11 is a block diagram showing a configuration of the baccarat table system according to the second embodiment.

FIG. 12 is a flowchart showing processing of the baccarat table system according to the second embodiment.

FIG. 13 is a diagram showing one example of a chip bet area displayed in the initial state on a bet display of the baccarat table system according to the second embodiment.

FIG. 14 is a diagram for illustrating the content of the game according to an optional rule which can be executed in the baccarat table system according to the second embodiment.

FIG. 15 is a diagram showing one example of the chip bet area displayed after a chip settlement on the bet display of the baccarat table system according to the second embodiment.

FIG. 16 is a diagram showing one example of a representation on the ruled line display of a ruled line display zone of the bet display of the baccarat table system according to the second embodiment.

FIG. 17 is a diagram showing one example of a history stored by a history storing unit of the baccarat table system according to the second embodiment.

FIG. 18 is a table showing a “condition” for determining whether to deal a banker side a card in baccarat.

### DESCRIPTION OF EXEMPLARY EMBODIMENTS

Baccarat is a popular casino game which uses cards (playing cards). Baccarat is a game where a dealer runs a competition between two imaginary persons (“BANKER” and “PLAYER”) and a game participant (user) bets on either of the two who the game participant expects to win. Here, players taking part in the game are the imaginary persons; thus the game participant can do nothing other than expecting which person wins and cannot intervene in the game except that.

The outcome of such a competition between a banker and a player depends on the total value of cards that the dealer draws from a shoe for dealing, where the 9 is the strongest, the smaller value is weaker for the subsequent smaller values such as 8 and 7, and the 0 is the weakest. The card “A (ace)” is counted as 1, the numbered cards except for 10 are counted as their respective value, and the numbered card 10 and the face cards are all counted as 0.

The outcome of the competition between a banker and a player is determined according to the following rule. Basically, the competition is settled by the right digit number of the total value of two cards. However, when a “condition” which will be described later occurs, the third card is added. The “condition” described above is as follows.

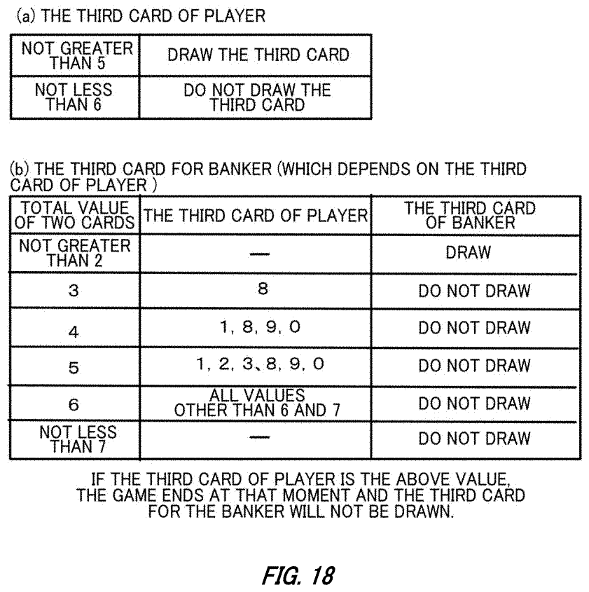

FIG. 18 is a table showing a “condition” which determines whether to distribute a card to a banker side in baccarat. A dealer deals a card to the player and the banker according to this “condition”. In other words, with the first two cards being dealt to the player and the banker, the third card is drawn when the total score of the player is not greater than “5”, and the third card is not drawn when the total score of the player is greater than or equal to “6”. On the other hand, the banker draws the third card when the total value of the two cards is not greater than “2”. And, the third card is not drawn under the following conditions. That is to say, the condition of the total value of the two cards of the banker being “3” and the value of the third card of the player being “8”, the condition of the total value of the two cards of the banker being “4” and the value of the third card of the player being any one of “1, 8, 9, 0”, the condition of the total value of the two cards of the banker being “5” and the value of the third card of the player being any one of “1, 2, 3, 8, 9, 0”, the condition of the total value of the two cards of the banker being “6” and the value of the third card of the player being any one of “all values other than 6 and 7”, and the condition of the total value of the two cards of the banker is not less than “7”.

Basically, customers bet chips on either of the “banker” or the “player” who they expect to win (betting). Alternatively, they can bet on the outcome, “TIE”, which unit a competition ends with an equal score.

The game is played using a baccarat table, which is a casino table. On the baccarat table, provided are a card arrangement area in which a dealer arranges cards, and bet areas surrounding this card arrangement area, which are for plurality of respective customers, for example 8 customers, in which the customers bet chips. In the card arrangement area, a banker-side card arrangement area in which cards are dealt as a banker's hand, and also a player-side card arrangement area in which cards are dealt as a player's hand are set.

The dealer deals cards not at dealer's own discretion, but according to the above-described baccarat rule. In other words, if the score of the player side is not greater than 5, the third card will be dealt to the player side. Whether to deal a card to the banker side is determined according to the table shown in FIG. 18.

Further, in each of the bet areas set up for the respective customers, provided are a “banker spot”, a “player spot” and further a “tie spot” for customers to bet chips in expectation of “banker” winning, “player” winning, and ending in a tie, respectively.

Note that, depending on the rules of the game, other bet spots can be provided in the bet areas. As the other bet spots, the following can be set up, such as a “pair spot” for expectation that the first two dealt cards are the same, a “big” for prediction that the game reaches a settlement with both the banker side and the player side ending with three cards per side, a “small” for prediction that the game reaches a settlement with both the banker side and the player side ending with two card per side.

In a game using such a baccarat table, the best part of the game is the action of squeezing a card (squeeze). The squeeze is an action of slowly turning over a dealt card hoping to see a desired number, and in principle, the right to squeeze the card is granted to the person with the highest bet amount.

When baccarat is played using such a casino table, the dealer exercises management of bet states, progression of a game, settlement of chips based on the outcome of the game, deal of cards, creating ruled lines for showing the history of the game for game participants and customers who will participate later to use as a reference, and the like.

In other words, once a bet time starts after the game begins, customers, or the game participants, take chips in their hands and place the chips in several types of bet spots bounded with lines (a banker spot, a player spot, a tie spot, and other spots).

Further, during the bet time, the dealer assigns the person with the highest bet, and determines whether each game participant observes the upper and lower bet limits and whether or not the rule (balance) is exceeded. All of these decisions are needed to be made by a single dealer, which places a considerable burden on the dealer.

Further, the dealer watches how the game participants bet their chips, and gives a verbal notice depending on how many chips can be additionally bet on the player side and on the banker side, or which side the popularity is biased toward. This handling also relies on the decision of the single dealer.

After the bet time ends, the dealer then speaks to the game participants to announce the close of the betting. Because this decision also needs to be made by the dealer, time and effort is possibly required to determine the ending; thus causing an overtime situation. In this case, some game participants may place a bet almost too late, which makes the game out of control and causes trouble during the progression of the game.

Once the game time starts, the dealer has to follow the rule specific to baccarat (the baccarat condition) as described above to deal cards.

When the outcome of the game is determined, the dealer handles chips based on the outcome of the game. The more game participants or bet chips there are, and further the more types of betting there are, the larger the burden is. In other words, operations of collection of wrong bets and adjustment of dividends according to the respective odds of right bets have to be done depending only on determination of the dealer, and correctly conducting such operations requires a lot of skill.

Further, after the outcome of the game is determined and handling of chips is finished, the dealer writes the outcome of the game (which is referred to as a ruled line) in a graph on paper by hand work. The ruled lines are intended for game participants who will participate in the game later. As many as 3 or 4 such ruled lines may have to be filled in. Therefore, the burden of the operation is large.

As can be seen from above, what the dealer has to handle widely ranges. So far, a variety of proposals have been made to reduce such burden on the dealer.

The baccarat table system according to one aspect of the present invention provides a baccarat table system which can reduce the burden on the dealer while keeping the situation where the game participants can enjoy the best part of baccarat.

A baccarat table system according to an embodiment is described. A first baccarat table system according to one aspect of the present invention includes a table presenting on its upper surface a competition progression area in which a dealer deals cards to progress a competition between two imaginary persons and a chip bet area having a plurality of bet spots which are set for each of game participants and set up in association with types of expectations about the competition between the two persons and on which each game participant bets chips based on expectation of that game participant, where the system includes: a card type output unit configured to output a type of a card dealt by a dealer; a bet display unit arranged to present a display screen on the upper surface of the table and configured to display the chip bet area for each of the game participants in a projected image; a bet area display control unit configured to sequentially change a display state of the chip bet area in the bet display unit responsive to a deal state of cards based on the output from the card type output unit; a competition history output unit configured to output a history of the competition based on the output from the card type output unit; and a chronological record storing unit configured to store histories output by the competition history output unit chronologically and in a manner manageable in a ledger, characterized in that the bet area display control unit can change a quantity and types of bet spots for expectations.

A second baccarat table system according to the embodiment includes a table presenting on its upper surface a competition progression area in which a dealer deals cards to progress a competition between two imaginary persons and a chip bet area having a plurality of bet spots which are set for each of game participants and set up in association with types of expectations about the competition between the two persons and on which each game participant bets chips based on expectation of that game participant, where the system includes: a card type output unit configured to output a type of a card dealt by a dealer; a bet display unit arranged to present a display screen on the upper surface of the table and configured to display the chip bet area for each of the game participants in a projected image; a bet area display control unit configured to sequentially change a display state of the chip bet area in the bet display unit responsive to a deal state of cards based on the output from the card type output unit; a bet designating unit arranged for each of the game participants and configured to designate a chip amount and a bet spot on which chips are bet according to an instruction from that game participant; a chip image display unit configured to display, in the designated bet spot in the chip bet area as a bet state, a chip image representing a chip bet in the bet display unit according to an instruction from the bet designating unit; a settling unit configured to settle bet chips based on an outcome of the competition; a chip image display changing unit configured to change a display state of the chip image in the bet display unit based on a result of the settlement; a competition history output unit configured to output a history of the competition based on the output from the card type output unit; and a chronological record storing unit configured to store histories output by the competition history output unit chronologically and in a manner manageable in a ledger, characterized in that the bet area display control unit can change a quantity and types of bet spots for expectations.

With such a configuration, according to the embodiment, the baccarat table system can be provided, which can reduce the burden on a dealer, while keeping the situation where the game participant can enjoy the best part of baccarat.

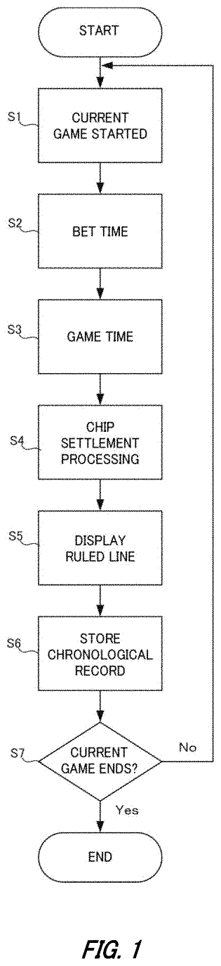

The following describes progression of the game for baccarat using the baccarat table system according to the embodiment. FIG. 1 is a flowchart showing in outline a flow of a casino game using the baccarat table system according to the embodiment. The game progresses similarly to a game using a typical baccarat table. In other words, when the current game is started (step S1), a bet time begins during which each game participant bets chips on a bet spot in a chip bet area based on expectation of that game participant (step S2). When the bet time ends, which is set to a certain period of time, a dealer deals cards to a banker side and a player side and a game time begins during which a competition between the two is run (step S3).

When the game ends, settlement processing on chips is performed based on the outcome of the game (step S4). Chips which have been bet on a wrong bet spot are collected, and dividend distribution is made according to chips which have been bet on a right bet spot. Then, this outcome of the game is reflected in a ruled line and displayed (step S5), the outcome of the game and balance of chips are stored as a chronological record (step S6). These procedures are repeated until the current game ends (step S7). Note that if cards stored in a shoe are used up, then the game will be suspended to refill the shoe with cards. In some cases, the game continues for 24 hours including suspensions.

### A First Embodiment

The following describes a baccarat table system according to a first embodiment.

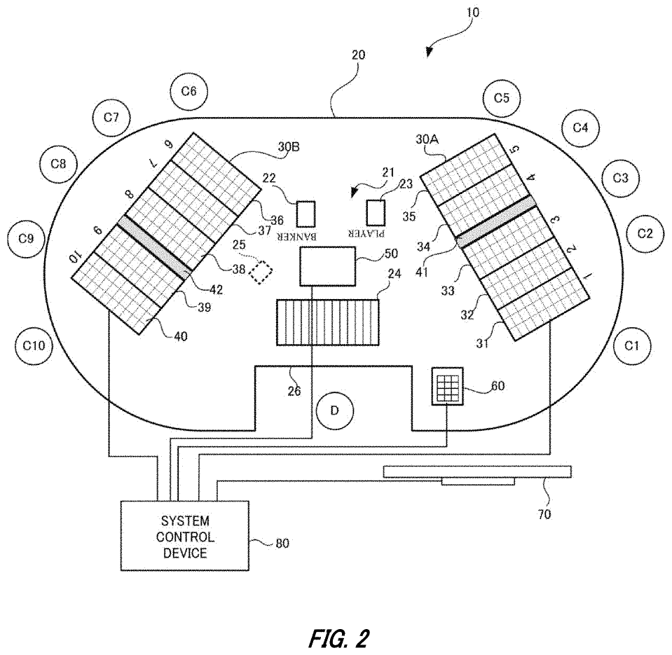

First, the overall configuration of the baccarat table system 10 is described. FIG. 2 is a schematic view showing an arrangement state of the baccarat table system according to the first embodiment of the present invention. Conventional cards and chips are used in the baccarat table system 10 according to this embodiment. Chips are bet by placing them on chip bet areas 31 to 40 displayed on screens of bet displays 30A and 30B displayed on a table 20.

The baccarat table system 10 includes the table 20, a dealer display 50 or a dealer display unit, which can be seen by the dealer, a numeric keypad 60 or a card type output unit, a ruled line display 70 or a ruled line display unit and a system control device 80.

The table 20 has an oval shape in which a cut-out portion 26 is formed, which is a location for a dealer D. On the table 20, a competition progression area 21 is also displayed, in which cards are dealt to progress a competition. A banker side 22 and a player side 23 are displayed on the competition progression area 21. The table 20 also has chip bet areas 31 to 40 set for a plurality of, 10 for this example, respective game participants C1 to C10. In this example, these chip bet areas 31 to 40 are displayed on the surface of the table 20 by displaying them on the two bet displays 30A and 30B which are each the bet area display unit. The bet displays 30A and 30B are each made up of a large-size liquid crystal display device, for example a 50-inch LCD.

Also, a chip tray 24 for placing chips and the dealer display 50 are arranged on the table 20. A card read window 25 may be also arranged.

The chip bet areas 31 to 35 used by the game participants C1 to C5 are displayed on the bet display 30A in a projected image, and the chip bet areas 36 to 40 used by the game participants C6 to C10 are displayed on the bet display 30B in a projected image. These bet displays 30A and 30B are controlled by the system control device 80 for display of the images. Note that when there is no need to distinguish the game participants C1 to C10 in the description, they are referred to simply as game participant C.

Also, on the bet display 30A, a card way 41 is set between the chip bet area 33 and the chip bet area 34, where the way is a card travelling area for the dealer D to give a card to any of the game participants C1 to C5. Similarly, on the bet display 30B, a card way 42 is set between the chip bet area 38 and the chip bet area 39, where the way is used for giving, by the dealer D, a card to any of the game participants C6 to C10 for squeezing. By giving cards through these card ways 41 and 42, unintended collapse of the stack of or movement of chips arranged in the chip bet areas 31 to 40 can be prevented.

The numeric keypad 60 is also arranged in the table 20 as a card type output unit configured to output a type (value) of a card dealt by the dealer D in the competition progression area 21. The card read window 25 described above or a card scanner arranged below the table may be used as a card type output unit.

Also, in the vicinity of the table 20 and behind the dealer D, the ruled line display 70 is arranged, which is a ruled line display unit configured to display a table showing the progress status of the game (the ruled lines).

The following describes the system control device 80. The system control device 80 implements each processing unit which will be described later by causing a computer to execute a processing program. The system control device 80 includes a CPU (Central Processing Unit) as processing device, a ROM (Read Only Memory) or RAM (Random Access Memory) as primary storage device, an HDD (Hard Disc Drive) or SSD (Solid State Drive) as secondary storage device, an input unit such as a keyboard and a mouse, and an output unit such as a display and a printer.

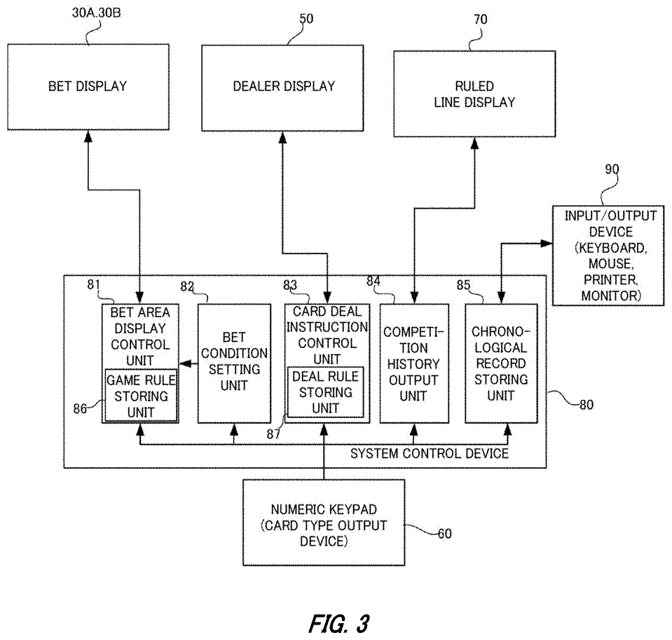

FIG. 3 is a block diagram showing a configuration of the baccarat table system according to the first embodiment of the present invention. The system control device 80 is connected to the bet displays 30A and 30B, the dealer display 50, the numeric keypad 60 and an input/output device 90.

The system control device 80 also includes a bet area display control unit 81, a bet condition setting unit 82, a card deal instruction control unit 83, a competition history output unit 84 and a chronological record storing unit 85. Each of these units is implemented by causing a computer to execute a processing program.

The bet area display control unit 81 displays various types of bet spots in each of the chip bet areas 31 to 40. In addition, the bet area display control unit 81 is configured to sequentially change display states of the plurality of bet spots in each of the chip bet areas 31 to 40 responsive to a deal state of cards, based on an output from the numeric keypad 60. The bet area display control unit 81 has a game rule storing unit 86 which stores a game rule indicating a hit or miss state of each bet spot based on the baccarat rule and a hit or miss state of each bet spot based on a unique rule which can be adopted as an option in this embodiment. According to this embodiment, a large number of bet spots can be created based on the exclusive rule.

The game participant C may bet on the “banker side win”, the “player side win” and the “tie”. In addition to the “banker”, the “player” and the “tie”, bet spots which are set as an option may be set up as bet spots in the chip bet areas 31 to 40, of which the number of types may be 26, for example

As the optional bet spots, the following can be set up, such as: a “pair spot” for expectation that the first two dealt cards are the same, a “big” for prediction that the game reaches a settlement with both the banker side and the player side ending with three card per side and a “small” for prediction that the game reaches a settlement with both the banker side and the player side ending with two cards per side.

After the bet time during which betting is permitted ends, the bet area display control unit 81 switches a representation of the chip bet areas to one indicating the ending, for example, to a text image showing, all over the chip bet areas 31 to 40, “NO MORE BET” to which the fill effect with black is added. Note that another representation may be used instead of this representation.

Also, the bet area display control unit 81 displays, on those of the bet spots that no longer have a possibility of being right (hit) during the progression of the competition, a representation indicating so. For example, those bet spots are displayed in black. This allows the game participants to recognize the current states of their bets at a glance, so that they get more interested in the game.

Further, the bet area display control unit 81 is configured to display, on those of the bet spots that have been determined to be right during the progression of the competition, a representation indicating so, or a brighter or blinking representation. This causes the game participants to be highly aware that their bets are right and grow elation, so that they get more and more interested in the game.

The bet condition setting unit 82 can perform setting by inputting an allowable upper limit amount for betting and the hitting odds for a bet spot. Then, the bet condition setting unit 82 sends this result to the bet area display control unit 81, which displays the allowable upper limit amount for betting and the hitting odds in each bet spot displayed in the chip bet areas 31 to 40. This allows the game participant C to obtain information about the bet and to bet according to the convenience of that game participant. Note that when the outcome of the game is determined, fixed odds are displayed in the chip bet areas 31 to 40. Information about complicated bets which may cause a plurality of (2 to 7) types of hitting odds for one betting can be easily recognized

The card deal instruction control unit 83 is configured to cause the dealer display 50 to display an instruction on dealing of cards based on an output from the numeric keypad 60 and according to the baccarat rule. To be specific, when either the player side or the banker side has a total score of 8 or 9 on the first two cards, the game ends at this moment. This is called a natural win and the one with the larger score is deemed to win. When both the player side and the banker side have a total score of 6 or 7 on the first two cards, this condition also results in end of the game. For cases with conditions other than those described above, the decision is made as follows. If the total score of the player side is 5 or smaller, the third card will be dealt to the player side. Whether to deal a card to the banker side is determined according to the predetermined rule (see FIG. 18). Accordingly, the dealer can deal cards in a correct and prompt manner; thus the burden is reduced.

The card deal instruction control unit 83, which has a deal rule storing unit 87 storing this rule, refers to this deal rule storing unit 87 to determine whether to deal the next card and the card after based on the appearance state of the current cards. Then, the card deal instruction control unit 83 explicitly displays a deal instruction on the dealer display 50 based on this determination.

The competition history output unit 84 causes the ruled line display 70 to display ruled lines based on the information from the numeric keypad 60. Owing to this, the dealer D does not need to record a history to create the ruled lines, so that the burden is reduced, and moreover, the ruled lines are displayed on the ruled line display unit. Therefore, the game participant C and those interested in the game can obtain information about previous competitions.

The chronological record storing unit 85 constantly records histories in a chronological manner. Then, it can output records of competitions run within a designated period of time, for example, operating time of a day, from the recorded histories. Further, the chronological record storing unit 85 can manage the histories in a ledger with a commonly used spreadsheet software or the like by sorting according to designated period of time, designated bet or odds in the bet. Such records can be printed out by a printer of the input/output device 90 or displayed on the display. This can help find mistake and misconduct of the play participants or the dealer.

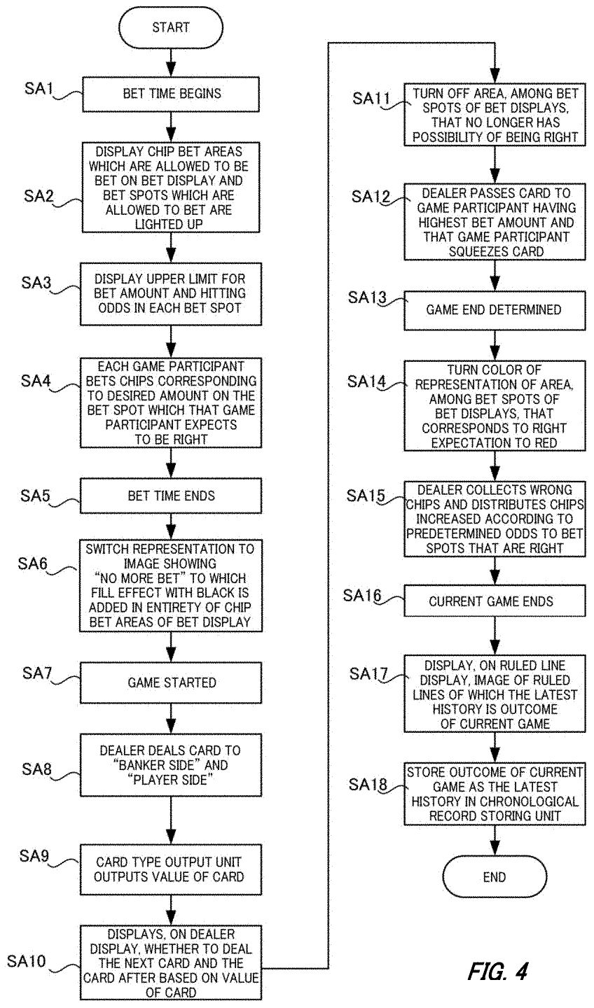

The following describes a flow of game using the baccarat table system 10 according to this embodiment along with a representation of each display. FIG. 4 is a flowchart showing processing of the baccarat table system according to this embodiment of the present invention.

When a game is started, a bet time begins (step SA1). Then, the bet area display control unit 81 causes the chip bet areas 31 to 40 of the bet displays 30A and 30B to be displayed, and bet spots which are allowed to be bet are lighted up (step SA2).

Further, the bet condition setting unit 82 displays an upper limit for bet amount and hitting odds in each bet spot of the chip bet areas 31 to 40 (step SA3). In this situation, each of the game participants C1 to C10 bets chips corresponding to desired amount on the bet spot which that game participant expects to be right (step SA4).

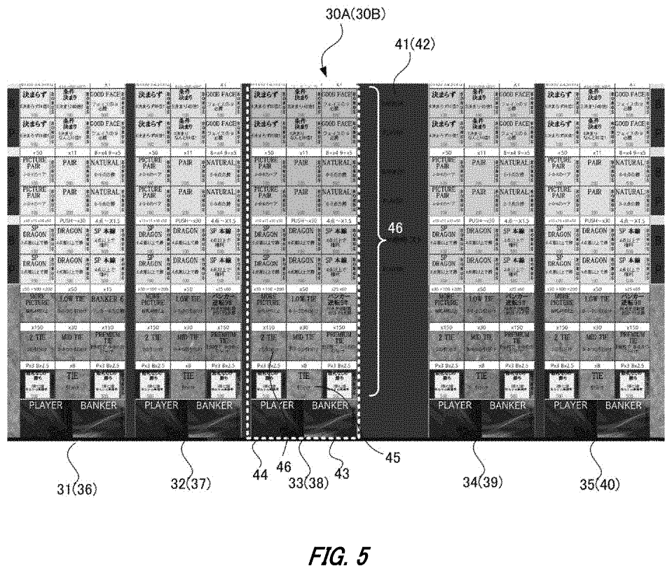

FIG. 5 is a diagram showing one example of the chip bet area displayed in the initial state on the bet display of the baccarat table system according to this embodiment of the present invention. The representations of the bet display 30A and the bet display 30B may be the same, or may be different or partially different from each other. Five chip bet areas 31 to 35 are displayed side by side on the bet display 30A. The card way 41 is formed between the chip bet area 33 and the chip bet area 34, and no representation is displayed in this card way 41.

The chip bet area 31 is intended for betting by the game participant C1, the chip bet area 32 is intended for betting by the game participant C2, the chip bet area 33 is intended for betting by the game participant C3, the chip bet area 34 is intended for betting by the game participant C4, and the chip bet area 35 is intended for betting by the game participant C5.

A plurality of bet spots, which is 29 bet spots in this example, are displayed in the chip bet areas 31 to 35. As can be seen by taking the chip bet area 33 as an example for description, a representation indicating a type of bet is displayed in each bet section. In other words, in the chip bet area 33, the representation “BANKER” is displayed in a bet spot 43, the representation “PLAYER” is displayed in a bet spot 44, and the representation “TIE” is displayed in a bet spot 45. The game participant C3 can bet on the “banker side win”, the “player side win” or the “tie” by placing chips on these bet spots.

In this embodiment, an area 46 is displayed, which has 26 types of bet spots, in addition to 3 types of bets described above and set in a typical baccarat. The representation of a target for betting and hitting odds is displayed in each bet spot of the area 46. The game participant C3 can place chips on each of these bet spots to bet each of the betting items. The similar representation is displayed in the other chip bet areas 31, 32, 34 and 35.

When the bet time ends (step SA5), the bet area display control unit 81 switches the representation to the image showing “NO MORE BET” to which the fill effect with black is added, in the entirety of the chip bet areas of the bet displays 30A and 30B (step SA6). This is the trigger for the card play performed by the dealer D (step SA7).

Once the play is started, the dealer D deals cards to the banker side 22 and the player side 23 in the competition progression area 21 to progress the game (step SA8). The progression of the game is the same as that of the standard baccarat. The dealer D operates the numeric keypad 60 to input the value of a card drawn from the shoe, and the numeric keypad 60 outputs this value (step SA9). In baccarat, values of cards are the matter of concern regardless of suits of the cards (heart, diamond, spade and club), and therefore the input can be performed with a numeric keypad. Note that certain marks may be input with the numeric keypad 60. This can implement the support of the exclusive bet areas. Further, the card deal instruction control unit 83 displays, on the dealer display 50, whether to deal the next card and the card after based on the value of the card received from the numeric keypad 60 (step SA10).

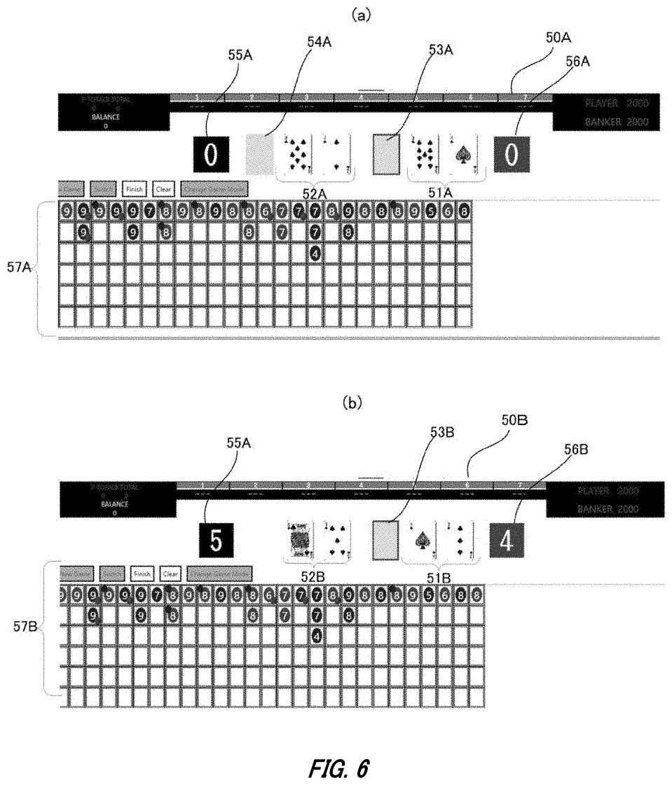

FIG. 6 is a diagram showing one example of a representation on a dealer display of the baccarat table system according to this embodiment of the present invention. Both (a) and (b) of FIG. 6 are representations in the state where two cards are given to each of the banker side and the player side. In this state, the dealer determines whether to give (deal) the next card and the card after according to the values of cards obtained by the two sides. This determination is made according to the rule described in the table shown in FIG. 18.

The representation 50A of the dealer display 50 shown in (a) of FIG. 6 showing the total score of “0” is displayed (reference numeral 55A) due to cards having values of “2” and “8” dealt to the banker side. On the other hand, cards with values of “1” and “9” were dealt to the player side, and the representation showing the total score of “0” is displayed (reference numeral 56A). Note that a ruled line area 57A showing how the game has progressed so far is displayed below the representation 50A.

In such a situation, the card deal instruction control unit 83 refers to the deal rule storing unit 87 to display a quadrangle 53 enclosed within a frame as an instruction to go on to give one card to the player side and display a quadrangle 54 as an instruction to subsequently give one card to the banker side. Note that the color of the quadrangles 53 and 54 may be one the dealer D can easily confirm, for example yellow green, and the color of the frame of the quadrangle 53 may be red.

The dealer D can visually recognize the representation 50A to confirm that an instruction has been issued to first give one card to the player side and further give one card to the banker side.

In the representation 50B on the dealer display 50 shown in FIG. 6, a representation is displayed showing cards having values of “1” and “3” have been dealt to the player side (reference numeral 51B) and the total score is “4” (reference numeral 55). On the other hand, a representation is displayed showing that cards having values of “5” and “0” have been dealt to the banker side (reference numeral 52B) and the total score is “5” (reference numeral 56B). Note that a ruled line area 57B showing how the game has progressed so far is displayed below the representation 50B.

In such a situation, the card deal instruction control unit 83 refers to the deal rule storing unit 87 to display a quadrangle 53B enclosed within a frame as an instruction to go on to give one card to the player side. Note that the color of the quadrangle 53B may be one the dealer D can easily confirm, for example yellow green, and the color of the frame of the quadrangle 53B may be red.

The dealer D can visually recognize the quadrangle 53B in the representation 50B to confirm that an instruction has been issued to give one card to the player side.

In this manner, the dealer D can confirm the contents displayed on the dealer display 50 to deal cards in a prompt and correct manner, without relying on the dealer D's own discretion.

On the other hand, the bet area display control unit 81 turns off (displays in black) any bet spot of the bet spots of the bet displays 30A and 30B as long as it no longer has a possibility of being right (step SA11). In this example, the bet spots which still have a possibility of being right are left lighted.

Then, during the progression of the game, the dealer D passes a card to the game participant having the highest bet amount through the card ways 41 and 42, and that game participant is allowed to squeeze the card (step SA12). In this way, the game participant C can enjoy the best part of baccarat to the fullest extent. In so doing, the card passed by the dealer D does not enter the chip bet areas 31 to 40, which can prevent the card from contacting chips that have been bet or making the chips untidy.

When the game is determined to end (step SA13), the bet area display control unit 81 turns the color of the representations of areas in the bet spots of the bet displays that correspond to right expectation to red (step SA14). Note that, even during the progression of the game, the bet which is determined to be right may be displayed in red whenever necessary.

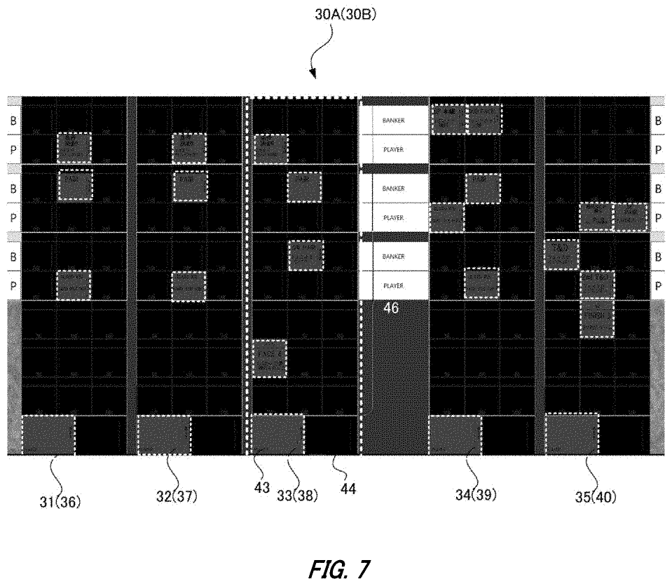

FIG. 7 is a diagram showing one example of the chip bet area displayed at the time of a game reaching a settlement on the bet display of the baccarat table system according to this embodiment of the present invention. In this example, the player side has won, and in the chip bet area 33, the bet spot 43 of the player side is lighted in red and the bet spot 44 of the banker side is turned off to appear in black. Also in an optional area 46, bet spots that are right are lighted in red and bet spots that are wrong are turned off to appear in black. In the figure, the lighted areas are indicated by enclosing with white dashed lines. The same display manner is applied to the other chip bet areas 31, 32, 34 and 35.

Then, based on the representations on these bet displays 30A and 30B, the dealer D collects the wrong chips and distributes chips increased according to predetermined odds to bet spots that are right (step SA15).

In so doing, the collection and the distribution of the chips can be performed according to the representations of the chip bet areas 31 to 40 on the bet displays 30A and 30B, so that the processing can be performed in a prompt and correct manner and the burden on the dealer D is reduced.

In this manner, the current game ends (step SA16), the competition history output unit 84 displays on the ruled line display 70 the image of the ruled lines of which the latest history is the outcome of the current game (step SA17).

The bet area display control unit 81 can also display hitting odds on the bet spots of the bet displays 30A and 30B that are right. Hitting odds are set and displayed on the bet spots even before betting, and when the game reaches a settlement, hitting odds are again displayed afresh at the time of hit. This display manner is taken because there are a number of contents of hit (odds) depending on betting states, and to make understood whichever pattern of hit at a glance at the time of the hit.

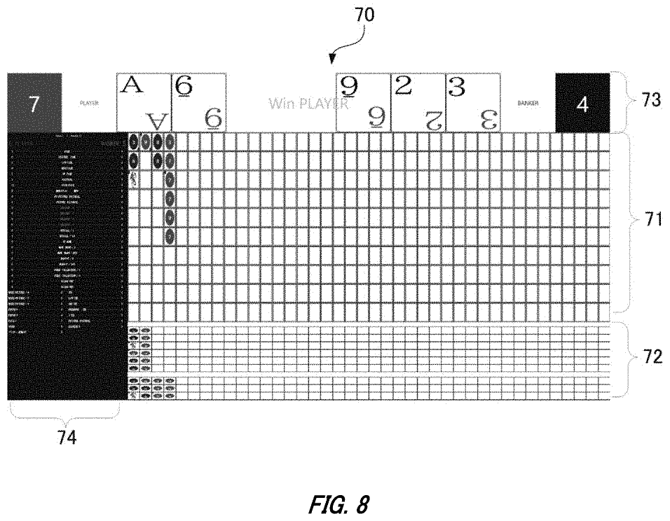

FIG. 8 is a diagram showing one example of a representation on the ruled line display of the baccarat table system according to this embodiment of the present invention. This representation is automatically displayed by the competition history output unit 84 based on an output from the numeric keypad 60. On the ruled line display 70, displayed are a primary ruled line representation 71 which is a set of ruled lines for showing chronological records of competitions, a secondary ruled line representation 72 which is an area for displaying the ruled lines in 3 cells or 6 cells, and a latest game outcome representation 73, and also a scoreboard 74 which indicates the number of times the baccarat hands appeared, as shown in FIG. 8.

The representations of this ruled line display 70 not only allows the game participants C1 to C10 to obtain information for grasping the trend of the game to expect future games, but also can make a chance for customers who are not the game participants to get interested in the game ongoing at this table 20 and participate in the game.

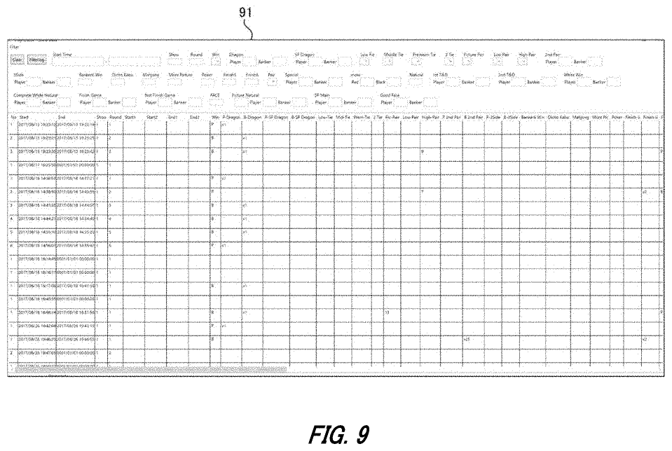

Further, the competition history output unit 84 stores the outcome of the current game as the latest history in the chronological record storing unit 85 (step SA18). FIG. 9 is a diagram showing one example of a history stored by a history storing unit of the baccarat table system according to this embodiment of the present invention. In a history 91 shown in FIG. 9, start time and date and end time and date of each game, a shoe in use, a round number, a winner, hit or miss for another option, and the like are recorded. Reference to this history 91 can help find misconduct or mistake of the play participants or the dealer. Also, it is possible to capture with a camera and save images of cards actually appeared on site in every game to check whether data output by the numeric keypad 60 coincides with the actual one.

Note that the bet area display control unit 81 may cause the bet displays 30A and 30B to display images for staging to liven up the game. The staging is to produce an excitement, such as in a Pachinko or a Japanese gambling machine, or a slot, at the moment where only one card is needed to hit the target (which is referred to as “hit-in-reach production”) for a betting with a large hitting odds (which can be designated).

For example, in the situation where a hit occurs if the last card is any of “10, J, Q and K (=value of “0”: 4 out of the 13 cards)” which have a high appearance probability, the representation all over the bet displays 30A and 30B are switched to a representation completely different from that for the betting, such as an image moving to the music while bet chips are left in place. In this manner, the mood of the game participants can be boosted.

As described above, with the baccarat table system 10 according to this embodiment, the burden on the dealer D can be reduced in all the processes involved in the progression of the game, and further the game can be progressed in a prompt and correct manner. In addition, with the baccarat table system 10, even if the number of game participants increases or the number of bet spots increases because of options, the burden on the dealer D does not increase.

### A Second Embodiment

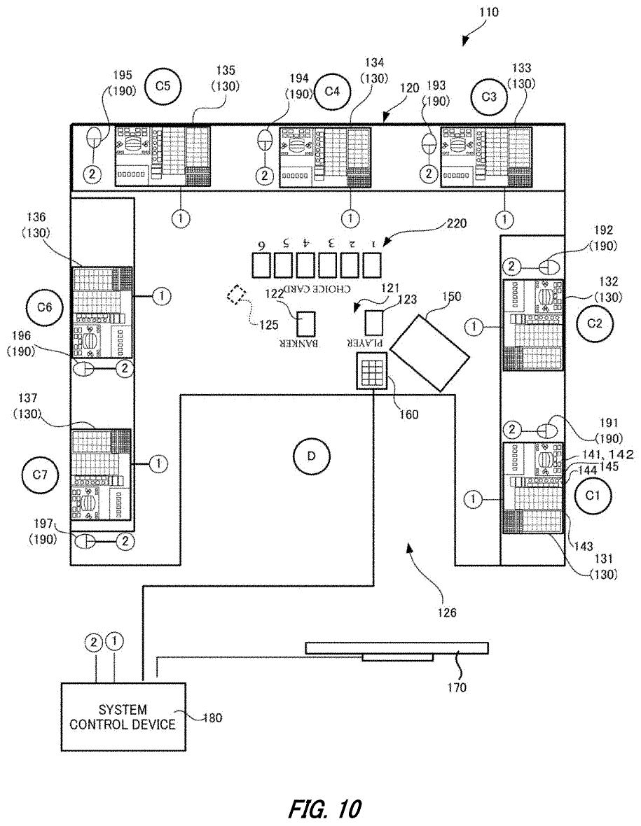

The following describes a baccarat table system according to a second embodiment. First, the overall configuration of the baccarat table system 110 is described. FIG. 10 is a schematic view showing an arrangement state of the baccarat table system according to the second embodiment of the present invention. The baccarat table system 110 according to this embodiment uses conventional cards, and chips are converted to ones in an electronic form. The chips are arranged for each of the game participants C1 to C7 in a table 120, and displayed on bet display 130 (131 to 137). Each of the game participants C1 to C7 operates a mouse 190 (191 to 197) which is a bet designating unit or operates the screen of a bet display 130 which is a bet designating unit on the table 120 by touching, to arrange, in a chip bet area, a chip image 145 displayed on the screen of the bet display 130 (131 to 137) for betting.

The baccarat table system 110 includes the table 120, a dealer display 150 or a dealer display unit, which can be seen by the dealer, a numeric keypad 160 or a card type output unit, an announcement display 170 or an information display unit configured to display information relating to a bet state and a system control device 180. The table 120 has a quadrangle planar shape in which a cut-out portion 126 which is a location for a dealer D is formed. The bet displays 131 to 137 are arranged on three sides of the table 120 that surround the cut-out portion 126.

On the table 120, a card arrangement portion 220 is also displayed, in which 6 cards can be arranged, where the cards are based on the exclusive rule that can be adopted uniquely by the baccarat table system 110 according to this embodiment. Six cards are to be arranged in this card arrangement portion 220.

On the table 120, a competition progression area 121 is displayed, in which cards are dealt to progress a competition. A banker side 122 and a player side 123 are displayed on the competition progression area 121. The table 120 also has the bet displays 131 to 137 arranged for each of a plurality of, in this example, 7 game participants C1 to C7. In this example, the bet displays 131 to 137 are each made up of 15-inch liquid crystal display device, for example. Note that when there is no need to distinguish the bet displays 131 to 137 in the description, they can be referred to simply as bet display 130, when there is no need to distinguish the game participants C1 to C7 in the description, they can be referred to simply as game participant C.

The baccarat table system 110 also includes mice 191 to 197 as a bet designating unit. Furthermore, a dealer display 150 is arranged on the table 120, which is a display device for a dealer, as will be described later. Note that a card read window 125 may be arranged on the table 120. The card read window 125 is used when a card scanner is used instead of the numeric keypad 160. Note that when there is no need to distinguish the mice 191 to 197 for the description, they are referred to simply as mouse 190.

In the bet display 130, chip bet areas 141 to 143 used by the game participant C and a chip display area 144 are displayed in a projected image. Each bet display 130 is controlled by the system control device 180. In the chip display area 144, the chip image 145 is displayed.

The game participant C operates the mouse 190 to move the chip image 145 displayed in the chip display area 144 on the bet display 130 to bet spots in the chip bet areas 141, 142 and 143 for betting.

Further, the numeric keypad 160 is arranged in the table 120 as a card type output unit operated by the dealer D and configured to output a type (value) of a card dealt in the competition progression area 121. The card read window 125 described above or a card scanner arranged at a shoe can be used as a card type output unit.

Also, the announcement display 170 is arranged in the vicinity of the table 120 and behind the dealer D. The announcement display 170, displays statistic data including at least one of: data pertaining to a bet state and a hit or miss state of chips and a cumulative total of won chips in each game for the game participants; data in terms of current and previous shoes, previous dates and previous months that is aggregated for the table; and data pertaining to hitting rates and the maximum points won at a single betting for the game participants.

When a conventional baccarat table is used, chips are bet on the table, and thus, on which spot and how many chips the respective game participants are betting, and hit or miss states for the respective game participants, and even cumulative totals of won chips for the respective users can be confirmed. With the baccarat table system 110 according to this embodiment, each game participant cannot confirm bet states of the other game participants. To address this, the announcement display 170 displays these pieces of information.

These pieces of information are displayed instead of using real chips in every game and for the current shoe, and odds for winning and won points are displayed. In addition, a ranking can be displayed, which is calculated based on data of previous shoes and also previous dates and previous months. Also, a hitting rate for each game participant, a record of bets which won the maximum points at a single betting, etc. can be displayed by setting.

The following describes the system control device 180. The system control device 180 implements each processing unit which will be described later by causing a computer to execute a processing program. The system control device 180 includes a CPU (Central Processing Unit) as processing device, a ROM (Read Only Memory) or RAM (Random Access Memory) as primary storage device, an HDD (Hard Disc Drive) or SSD (Solid State Drive) as secondary storage device, an an input unit such as a keyboard, a mouse and a touch panel, and an output unit such as a display and a printer.

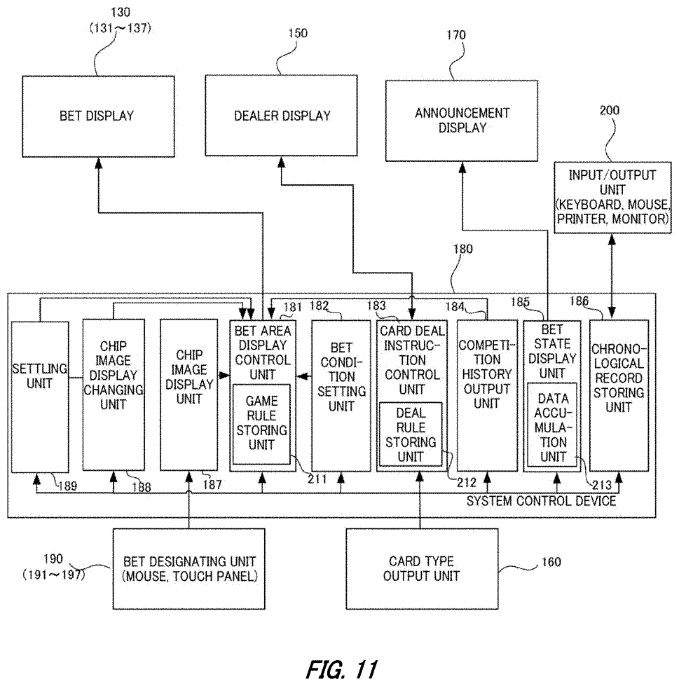

FIG. 11 is a block diagram showing a configuration of the baccarat table system according to the second embodiment of the present invention. The system control device 180 is connected to the bet display 130 (131 to 137), the dealer display 150, the numeric keypad 160, the announcement display 170 which is an information display unit to display bet states of chips in each game or the like, the mouse 190 (191 to 197) and an input/output device 200. Note that a touch panel may be arranged on the bet display 130 to touch the screen of the bet display 130 for betting, instead of using the mouse 190.

Also, the system control device 180 has a bet area display control unit 181, a bet condition setting unit 182, a card deal instruction control unit 183, a competition history output unit 184, a bet state display unit 185 configured to generate an information image of bet information, a chronological record storing unit 186, a chip image display unit 187, a chip image display changing unit 188 and a settling unit 189. Each of these units is implemented by causing a computer to execute a processing program.

The bet area display control unit 181 is configured to display chip bet areas 141 to 143 having various types of bet spots on the display screens of the bet displays 131 to 137 and a chip display area 144 in which the chip image 145 is displayed. Note that a large number of bet spots can be created based on the exclusive rule. The bet area display control unit 181 may also display a ruled line display zone 146 for showing ruled lines on the bet display 130 and an optional game display zone 147. The data for displaying the ruled line display zone 146 is obtained from the competition history output unit 184.

In addition, based on an output from the numeric keypad 160, the bet area display control unit 181 is configured to sequentially change display states of the plurality of bet spots in the chip bet areas 141 to 143 on the bet display 130 responsive to a deal state of cards. The bet area display control unit 181 has a game rule storing unit 211 which stores a game rule indicating a hit or miss state of each bet spot based on the baccarat rule and a hit or miss state of each bet spot based on a unique rule which can be adopted as an option in this embodiment. In other words, the game rule storing unit 211 stores a rule that is set as an option, in addition to a traditional baccarat rule.

The game participant C may bet on the “banker side win”, the “player side win”, the “tie” and the like. In addition to the “banker”, the “player” and the “tie”, bet spots based on the rule that is set as an option may be set up as bet spots in the chip bet areas 141 to 143, of which the number of types may be 20 or more, for example

As the optional bet spots, the following can be set up, such as: a “pair spot” for expectation that the first two dealt cards are the same, a “big” for prediction that the game reaches a settlement with both the banker side and the player side ending with three card per side and a “small” for prediction that the game reaches a settlement with both the banker side and the player side ending with two cards per side. Although the types and numbers of the optional bet spots are set in advance, the game participants can select, from these bet spots, bet spots by themselves at will to cause the selected bet spots to be displayed.

After the bet time during which betting is permitted ends, the bet area display control unit 181 causes a representation indicating the ending to be displayed in the chip bet areas, for example a text image showing “NO MORE BET” to which the fill effect with black is added to be displayed all over the chip bet areas 141 to 143 and further bet processing is prohibited. In other words, clicking the mouse 190 does not work, or operation via a touch panel cannot work. Note that this representation may be another representation.

Also, the bet area display control unit 181 displays, on those of the bet spots that no longer have a possibility of being right (hit) during the progression of the competition, a representation indicating so. For example, those bet spots are displayed in black. This allows the game participants to recognize the current states of their bets at a glance, so that they get more interested in the game.

Further, the bet area display control unit 181 is configured to display, on those of the bet spots that have been determined to be right during the progression of the competition, a representation indicating so, or a brighter or blinking representation. This causes the game participants to be highly aware that their bets are right and grow elation, so that they get more and more interested in the game.

The bet area display control unit 181 may also have a function of a bet amount adjusting unit to adjust bet amounts of all the game participants at a certain ratio when a difference between bet amount totals bet respectively on the player and the banker by the game participants exceeds a predetermined value set in advance, so that the difference does not go beyond the predetermined value. This can prevent the difference between the bet amount totals bet respectively on the player and the banker on the game from being equal to or larger than a certain amount.

The bet condition setting unit 182 can set an allowable upper limit amount for betting and the hitting odds for a bet spot. Then, the bet condition setting unit 182 sends these set values to the bet area display control unit 181, which displays the allowable upper limit amount for betting and the hitting odds in each bet spot displayed in the chip bet areas 141 to 143. This allows the game participant C to obtain information about the bet and to bet according to the convenience or preference of that game participant.

The card deal instruction control unit 183 causes the dealer display 150 to display an instruction on dealing of cards based on an output from the numeric keypad 160 and according to the baccarat rule. To be specific, when either the player side or the banker side has a total score of 8 or 9 on the first two cards, the game ends at this moment. This is called a natural win and the one with the larger score is deemed to win. When both the player side and the banker side have a total score of 6 or 7 on the first two cards, this condition also results in end of the game. For cases with conditions other than those described above, the decision is made as follows. If the total score of the player side is 5 or smaller, the third card will be dealt to the player side. Whether to deal a card to the banker side is determined according to the predetermined rule (see FIG. 18). Accordingly, the dealer can deal cards in a correct and prompt manner; thus the burden is reduced.

The card deal instruction control unit 183 has a deal rule storing unit 212 which stores this rule. The card deal instruction control unit 183 refers to this deal rule storing unit 212 to determine whether to deal the next card and the card after based on the appearance state of the current cards. Then, the card deal instruction control unit 183 explicitly displays a deal instruction on the dealer display 150 based on this determination.

The competition history output unit 184 causes the bet display 130 to display ruled lines based on the information from the numeric keypad 160. Further, the bet area display control unit 181 causes the ruled lines to be displayed in the ruled line display zone 146 on the bet display 130. Owing to this, the dealer D does not need to record a history to create the ruled lines, so that the burden is reduced, and moreover, the ruled lines are displayed on the ruled line display unit, so that the game participant C and those interested in the game can obtain information about previous competitions.

The bet state display unit 185 has a data accumulation unit 213. The data accumulation unit 213 stores data pertaining to a bet state and a hit or miss state of chips and a cumulative total of won chips in each game for the game participants; data in terms of current and previous shoes, previous dates and previous months that is aggregated for the table; and statistic data pertaining to hitting rates and the maximum points won at a single betting for the game participants. Note that the data accumulation unit 213 may include at least one of these pieces of data as appropriate. Alternatively, the data accumulation unit 213 may store another statistic data as appropriate.

The bet state display unit 185 creates image data such as a table, a graph, etc. based on the data required as per a setting to display them on the announcement display 170.

The chronological record storing unit 186 constantly records histories in a chronological manner. Then, it can output records of competitions run within a designated period of time, for example, operating time of a day from the recorded histories. Further, the chronological record storing unit 85 can manage the histories in a ledger with a commonly used spreadsheet software or the like by sorting according to designated period of time, designated bet or respective odds in the bet. Such records can be printed out by a printer of the input/output device 200 or displayed on the display. This can help find mistake and misconduct of the play participants or the dealer.

The chip image display unit 187 displays the chip image 145 on the bet display 130. The quantity, etc. are determined based on types of chips which have been set and how many chips the respective customers possess. The chip image 145 has a shape and a design intended to simulate the actual chip.

The chip image display changing unit 188 changes a representation of the chip image 145 by operating the mouse 190 or operating the screen of the bet display 130 by touching. In other words, it is possible to change the number of chip images 145 to be displayed, or move them to the chip bet areas 141 to 143, according to betting. Also, it is possible to cause the representation of the chip image 145 to disappear or to cause the number of the chip images 145 to increase, on the bet display 130 based on a settlement result by the settling unit 189.

The settling unit 189 settles chips based on the outcome of the game progressed by the dealer in the competition progression area 121. The settlement is made based on the game rule stored in the game rule storing unit 211.

The following describes a flow of game using the baccarat table system 110 according to this embodiment along with a representation of each display.

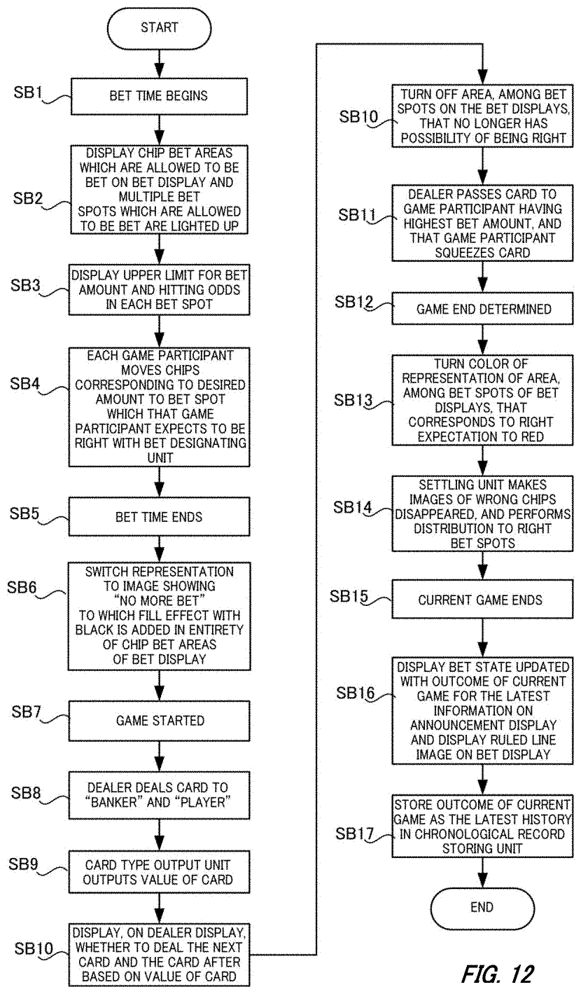

FIG. 12 is a flowchart showing processing of the baccarat table system according to the second embodiment of the present invention.

When a game is started, a bet time begins (step SB1). Then, the bet area display control unit 181 causes the chip bet areas 141 to 143 to be displayed on the bet displays 131 to 137, and bet spots which are allowed to be bet are lighted up (step SB2).

Further, the bet condition setting unit 182 displays an upper limit for bet amount and hitting odds in each bet spot of the chip bet areas 141 to 143 (step SB3). In this situation, each of the game participants C1 to C7 bets chips corresponding to desired amount on the bet spot which that game participant expects to be right (step SB4).

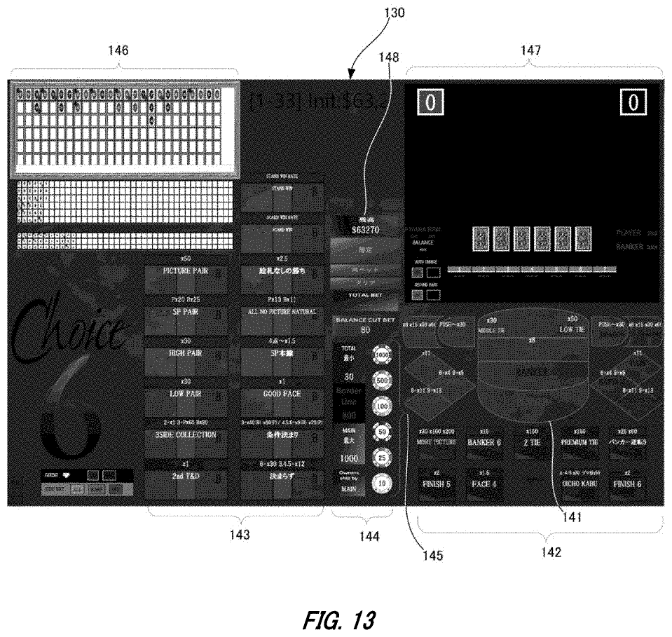

FIG. 13 is a diagram showing one example of a chip bet area displayed in the initial state on a bet display of the baccarat table system according to the second embodiment of the present invention. On the bet display 130, displayed are the underlying chip bet area 141 showing “BANKER”, “PLAYER”, “TIE” and the like, uniquely set and optional chip bet areas 142 and 143, the chip display area 144 in which the chip image 145 is displayed, the ruled line display zone 146, the optional game display zone 147 and a chip balance 148.

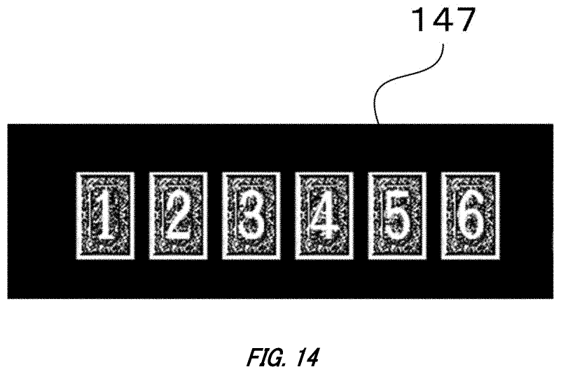

Six cards are displayed in the optional game display zone 147 as shown in FIG. 14. The optional game adopted by the baccarat table system 110 according to this embodiment is that the game participant C is allowed to select a card from the 6 cards dealt in advance in the card arrangement portion 220. This enhances the excitement of game feature. The rule of this optional game is stored in the game rule storing unit 211.

When the bet time ends (step SB5), the bet area display control unit 181 displays, all over the chip bet areas of the bet display 130, a text image showing “NO MORE BET” to which the fill effect with black is added (step SB6), and further bet processing is prohibited. In other words, clicking the mouse 190 does not work, or operation via a touch panel cannot work. This is the trigger for the card play performed by the dealer D (step SB7).

Once the play is started, the dealer D deals cards to the banker side 122 and the player side 123 in the competition progression area 121 to progress the game (step SB8). The progression of the game is the same as that of the standard baccarat. The dealer D operates the numeric keypad 160 to input the value of a card drawn from the shoe, and the numeric keypad 160 outputs this value (step SB9). In baccarat, values of cards are the matter of concern regardless of suits of the cards (heart, diamond, spade and club), and therefore the input can be performed with a numeric keypad. Note that certain marks may be input with the numeric keypad 160. This can implement the support of the exclusive bet areas. Further, the card deal instruction control unit 183 displays, on the dealer display 150, whether to deal the next card and the card after based on the value of the card received from the numeric keypad 160 (step SB10).

The representation of the dealer display 150 is described based on FIG. 6. Both (a) and (b) of FIG. 6 are representations in the state where two cards are given to each of the banker side and the player side. In this state, the dealer determines whether to give the next card and the card after according to the values of cards given to the two sides. This determination is made according to the rule described in the table shown in FIG. 18.

Note that a table can be displayed on the dealer display 150, where the table can tell the person with the highest bet amount of the game participants and how much and on which of the player side and the banker side each game participant is betting (the table is referred to as “owner graph”). Viewing this owner graph, the dealer can easily determine the person with the highest bet amount, to pass a card smoothly and prompt the person to perform the squeeze.

The representation 50A of the dealer display 150 shown in (a) of FIG. 6 showing the total score of “0” is displayed (reference numeral 55A) due to cards having values of “2” and “8” dealt to the banker side. On the other hand, cards with values of “1” and “9” were dealt to the player side, and the representation showing the total score of “0” is displayed (reference numeral 56). Note that a ruled line area 57A showing how the game has progressed so far is displayed below the representation 50A.

In such a situation, the card deal instruction control unit 183 refers to the deal rule storing unit 212 to display a quadrangle 53 enclosed within a frame as an instruction to go on to give the one card to the player side and display a quadrangle 54 as an instruction to subsequently give one card to the banker side. Note that the color of the quadrangles 53 and 54 may be one the dealer D can easily confirm, for example yellow green, and the color of the frame of the quadrangle 53 may be red.

The dealer D can visually recognize the representation 50A to confirm that an instruction has been issued to first give one card to the player side and further give one card to the banker side.

In the representation 50B on the dealer display 150 shown in FIG. 6, a representation is displayed showing cards having values of “1” and “3” have been dealt to the player side (reference numeral 51B) and the total score is “4” (reference numeral 55). On the other hand, a representation is given showing cards having values of “5” and “0” have been dealt to the banker side (reference numeral 52B) and the total score is “5” (reference numeral 56B). Note that a ruled line area 57B showing how the game has progressed so far is displayed below the representation 50B.

In such a situation, the card deal instruction control unit 183 refers to the deal rule storing unit 212 to display a quadrangle 53B enclosed within a frame as an instruction to go on to give one card to the player side. Note that the color of the quadrangle 53B may be one the dealer D can easily confirm, for example yellow green, and the color of the frame of the quadrangle 53B may be red.

The dealer D can visually recognize the quadrangle 53B in the representation 50B to confirm that an instruction has been issued to give one card to the player side.

In this manner, the dealer D can confirm the contents displayed on the dealer display 150 to deal cards in a prompt and correct manner, without relying on the dealer D's own discretion.

On the other hand, the bet area display control unit 181 can change the color of any bet spot of the bet spots of the chip bet areas 141 to 143 on the bet displays 130 darker as long as it no longer has a possibility of being right (step SB11). In this example, the representations of the bet spots which still have a possibility of being right are left as they are.

Then, at the end of the game, the dealer D passes a card to the game participant having the highest bet amount, and that game participant squeezes the card (step SB12). The game participants can enjoy the best part of baccarat to the fullest extent.

When the game is determined to end (step SB13), the bet area display control unit 181 turns, to gold, the color of the representations of those bet spots of the bet displays that correspond to right expectation (step SB14).

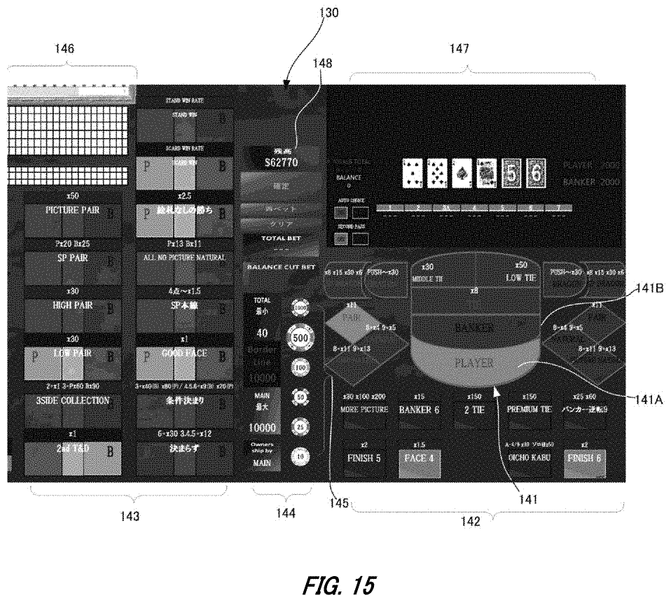

FIG. 15 is a diagram showing one example of the chip bet area displayed at the time of a game reaching a settlement on the bet display of the baccarat table system according to the second embodiment of the present invention. In this example, the player side has won and in the chip bet area 141, the color of the bet spot 141A of the player side has turned gold and the color of the bet spot 141B of the banker side has turned dark. In addition, the bet spots that are right are lighted in gold and the color of the bet spots that are wrong turned dark, in the chip bet areas 142 and 143.

Then, based on this result, the settling unit 189 makes the images of the wrong chips disappeared, distributes a predetermined odds to the right bet spots, and displays a representation indicating so on the chip display area 144 (step SB15). The result is reflected to the chip balance 148 on the bet display 130 of each game participant C. Then, the won points are displayed together with the text, “Congratulations” on the entire screen of the bet display 130.

In so doing, the chip settlement is processed by the settling unit 189, allowing the processing to be performed in a prompt and correct manner and the burden on the dealer D to be reduced.

In this manner, the current game ends, and the bet state display unit 185 displays the bet state image updated with the outcome of the current game for the latest information on the announcement display 170 (step SB16).

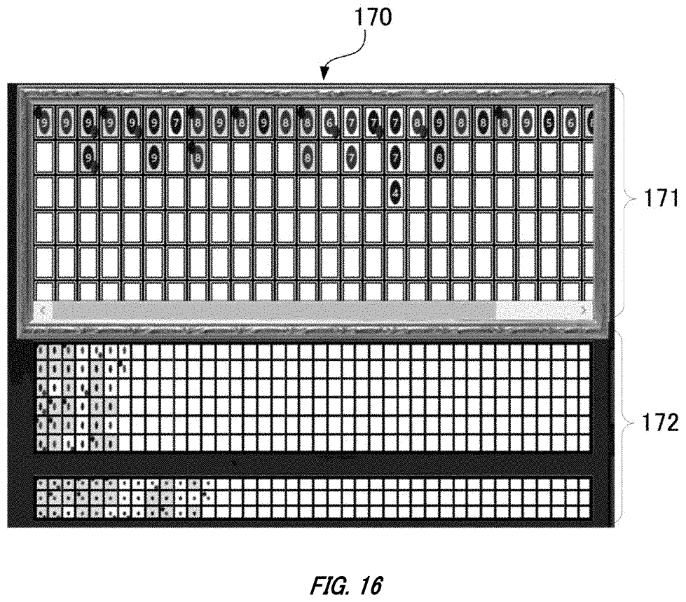

Also, the competition history output unit 184 displays ruled line information in the ruled line display zone 146 of the bet display 130. FIG. 16 is a diagram showing one example of a representation on the ruled line display of the ruled line display zone of the bet display of the baccarat table system according to the second embodiment of the present invention.

This representation is automatically displayed by the competition history output unit 184 based on an output from the numeric keypad 160. In the ruled line display zone 146 of the bet display 130, displayed are a representation 171 that is a set of ruled lines for showing the chronological records of competitions and a score history 172 that is an area for displaying the ruled lines in 3 cells or 6 cells, as shown in FIG. 16.

The representations of these areas 171 and 172 allow the game participants C1 to C7 to obtain information for grasping the trend of each game to expect future games.

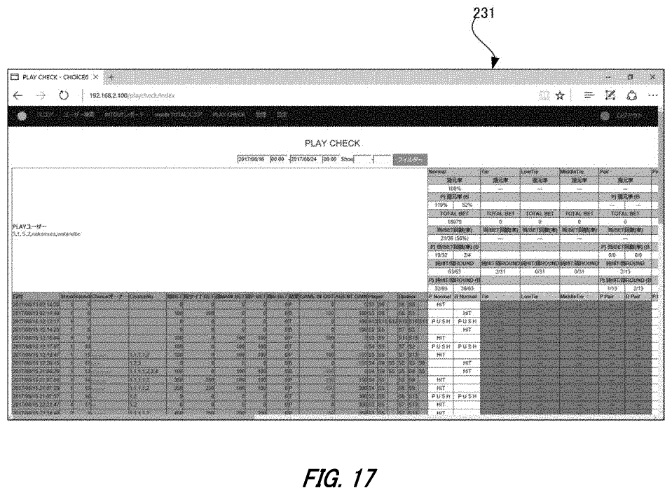

Further, the competition history output unit 184 stores the outcome of the current game as the latest history in the chronological record storing unit 186 (step SB17). FIG. 17 is a diagram showing one example of a history stored by the history storing unit of the baccarat table system according to the second embodiment of the present invention. In a history 231 shown in FIG. 17, start time and date and end time and date of each game, a shoe in use, a round number, a winner, hit or miss for another option, and the like are recorded. Reference to this history 231 can help find misconduct or mistake of the play participants or the dealer.

As described above, with the baccarat table system 110 according to this embodiment, the burden on the dealer D can be reduced in all the processes involved in the progression of the game, and further the game can be progressed in a prompt and correct manner. In addition, with the baccarat table system 110, even if the number of game participants increases, or the number of bet spots increases because of options, the burden on the dealer D does not increase.

The baccarat table system 110 according to this embodiment can provide a baccarat table system which can reduce the burden on a dealer, while keeping the situation where the game participants can enjoy the best part of baccarat.

In other words, according to the baccarat table system 110 of this embodiment, a competition progression area in which a dealer deals cards to progress a competition between two imaginary persons and a chip bet area having a plurality of bet spots set for each of game participants and set up in association with types of expectations about the competition between the two persons, the game participants betting chips on the plurality of bet spots based on expectations of the game participants, are presented on an upper surface of a table, a card type output unit outputs a type of a card dealt by the dealer, a bet display unit is arranged to present a display screen on the upper surface of the table and configured to display the chip bet area for each of the game participants in a projected image, and a bet area display control unit sequentially changes a display state of the chip bet area in the bet display unit responsive to a deal state of cards.

Therefore, the play participants can bet chips on the bet spots in the chip bet areas displayed on the table and observe on site the dealer actually dealing cards to run the competition between the two imaginary persons, allowing the game participants to enjoy the best part of baccarat such as card handling by the dealer and squeeze of a card. Further, in this situation, a display state of the chip bet areas are changed responsive to the state of a game as the game progresses, so that the dealer and the game participants can easily grasp the state of bet chips, and particularly the burden on the dealer is reduced and the processing of the game can be performed in a prompt and correct manner.

In addition, according to the baccarat table system 110 of this embodiment, a competition history output unit outputs a history of the competition based on the output from the card type output unit, and a chronological record storing unit stores histories output by the competition history output unit chronologically and in the manner manageable in a ledger. Also, the bet area display control unit can change the quantity and the types of bet spots for expectations. Accordingly, the histories of competitions can be chronologically managed in a ledger, and particularly, even if types of betting increases to a large number due to change in the quantity and the types of bet spot by the bet area display control unit, the histories of the baccarat table system can be easily managed in a ledger. Also, the bet area display control unit can create bet spots for expectations, so that any prediction can be displayed as a bet spot in the chip bet area for operation. Accordingly, it is possible to draw the interest of the game participants by adding novel expectations not seen in conventional baccarat rules.

Further, according to the baccarat table system 110 of this embodiment, a competition progression area in which a dealer deals cards to progress a competition between two imaginary persons and a chip bet area having a plurality of bet spots set for each of game participants and set up in association with types of expectations about the competition between the two persons, the game participants betting chips on the plurality of bet spots based on expectations of the game participants, are presented on the upper surface of the table, a card type output unit outputs a type of a card dealt by the dealer, a bet display unit is arranged to present a display screen on the upper surface of the table and configured to display the chip bet area for each of the game participants in a projected image, and a bet area display control unit changes a display state of the chip bet area in the bet display unit responsive to a deal state of cards.

Further, the game participants designate, using a bet designating unit arranged for each of the game participants, a chip amount and a bet spot on which chips are bet according to an instruction from that game participant, a chip image display unit displays, in the designated bet spot in the chip bet area as a bet state, a chip image representing a chip bet through the bet display unit according to an instruction from the bet designating unit, and in addition, a settling unit settles bet chips based on an outcome of the competition.

Therefore, the play participants can use the bet designating unit to bet chip images on the bet spots in the chip bet area displayed on the table, and observe on site the dealer actually dealing cards to run the competition between the imaginary two persons. Accordingly, the game participants can enjoy the best part of baccarat such as card handling by the dealer and squeeze of a card. Also, in this situation, the settlement processing is performed on the chips based on the outcome of the competition upon the ends of the game, so that the dealer does not need to handle the chips, and moreover the game participants can easily grasp how the bet chips have been processed. Accordingly, the burden on the dealer is reduced, games can be processed in a prompt and correct manner, and misconduct does not occur.

In addition, according to the baccarat table system 110 of this embodiment, a competition history output unit outputs a history of the competition based on the output from the card type output unit, and a chronological record storing unit stores histories output by the competition history output unit chronologically and in the manner manageable in a ledger. Also, the bet area display control unit can change the quantity and the types of bet spots for expectations. Accordingly, the histories of competitions can be chronologically managed in a ledger, and particularly, even if types of betting increases to a large number due to change in the quantity and the types of bet spots by the bet area display control unit, the histories of the baccarat table system can be easily managed in a ledger. Also, the bet area display control unit can create bet spots for expectations, so that any prediction can be displayed as a bet spot in the chip bet area for operation. Accordingly, it is possible to draw the interest of the game participants by adding novel expectations not seen in conventional baccarat rules.

Also, according to the baccarat table system 110 of this embodiment, the bet display unit is arranged to present a display screen on the upper surface of the table, and displays on each of one or more display devices the chip bet area for each of the game participants in a projected image with the chip bet areas displayed separately in association with the respective game participants, so that a number of chip bet areas can be displayed on a single display device.

Also, according to the baccarat table system 110 of this embodiment, an announcement display can display statistic data including at least one of: data pertaining to a bet state and a hit or miss state of chips and a cumulative total of won chips in each game for each of the game participants; data in terms of current and previous shoes, previous dates and previous months that is aggregated for the table; and data pertaining to hitting rates and the maximum points won at a single betting for the game participants. Therefore, each game participant can confirm the bet states of the other game participants.

According to the baccarat table system 110 of this embodiment, the instruction on dealing of cards according to the baccarat rule that is issued from the card deal instruction control unit is displayed on the dealer display which can be seen by the dealer. Therefore, the dealer can deal cards in a correct and prompt manner, and the burden is reduced.

According to the baccarat table system 110 of this embodiment, a ruled line display unit displays a ruled line which is the history of the competition based on the output history. Therefore, the dealer does not need to record a history to create the ruled lines, so that the burden is reduced, and moreover, the ruled lines are displayed on the ruled line display unit, so that the game participant and those who are interested in the game can obtain information about previous competitions.

According to the baccarat table system 110 of this embodiment, a bet condition setting unit sets an allowable upper limit amount for betting and the hitting odds for each of the bet spots, and the bet display unit displays the upper limit amount and the hitting odds. Therefore, each of the game participants can obtain information about the bet and bet according to the convenience of that game participant.

According to the baccarat table system 110 of this embodiment, after a period of time during which betting is permitted elapses, the bet area display control unit displays, on the chip bet area, a representation indicating that the period of time during which betting is permitted elapsed, for example, it displays the chip bet area in black. Therefore, the game participants recognize whether or not betting is permitted at a glance, and the dealer can easily manage the close of betting, resulting in reduction in the burden on the dealer.

According to the baccarat table system 110 of this embodiment, the bet area display control unit displays on the bet spots that no longer have a possibility of being right during the progression of the competition, a representation indicating that the bet spots no longer have the possibility of being right, for example displays in black or marks with X those bet spots. Therefore, the game participants can recognize the current states of their bets at a glance, and get more interested in the game.

According to the baccarat table system 110 of this embodiment, it is possible to display, on those of the bet spots that have been determined to be right during the progression of the competition, a representation indicating that those bet spots have been determined to be right during the progression of the competition or a brighter or blinking representation. Therefore, the game participants are highly aware that their bets are right and grow elation, so that they get more and more interested in the game.

According to the baccarat table system 110 of this embodiment, a bet amount adjusting unit supervises all the bet designating unit for the game participants, and when a difference between bet amount totals bet respectively on a player and a banker that depends on the aggregate total of bet amounts by all the game participants and that is calculated based on bet states of the bet spots exceeds a set value, adjusts bet amounts of all the game participants at a certain ratio, so that this difference does not go beyond the value. Therefore, the difference being equal to or larger than a certain value can be prevented, where the difference is a difference between bet amount totals bet respectively on a player and a banker for a game.

According to the baccarat table system 110 of this embodiment, the card travelling area for giving a card to the game participants is provided between the chip bet areas on the table. Therefore, when the dealer gives a card to a game participant for the game participant to perform the squeeze, the card to be given does not enter the chip bet areas, which can prevent the card from contacting chips that have been bet or making the chips untidy.

According to the baccarat table system 110 of this embodiment, a data accumulation unit accumulates statistic data including at least one of: data pertaining to a bet state and a hit or miss state of chips and a cumulative total of won chips in each game for the game participants; data in terms of current and previous shoes, previous dates and previous months that is aggregated for the table; and data pertaining to hitting rates and the maximum points won at a single betting for the game participants, and a visualized data generating unit outputs, as a visualized representation data, designated data; and an information display unit displays an image based on the visualized representation data. Therefore, the game participants and customers around the table can visually recognize the information display unit to grasp a bet state and a hit or miss state of chips and a cumulative total of won chips in each game for the game participants, states in terms of current and previous shoes, previous dates and previous months that are aggregated for the table and hitting rates and the maximum points won at a single betting for the game participants, and the game participants and other customers develop much more interest in the game.

According to the baccarat table system 110 of this embodiment, when a bet amount limit is exceeded in any of the bet spots, a bet area display control unit prohibits betting on that bet spot, and after a period of time during which betting is permitted elapses, the bet area display control unit prohibits further betting on the chip bet area. Therefore, betting with a bet amount exceeding the bet amount limit and betting after the elapse of bet time are prevented, so that progression of the game in a smooth and fair manner can be achieved.

### INDUSTRIAL APPLICABILITY

The baccarat table system according to one aspect of the present invention can reduce the burden on a dealer while keeping the situation where game participants can enjoy the best part of baccarat; thus the system has industrial availability.

### EXPLANATION OF REFERENCES

10: baccarat table system, 20: table, 21: competition progression area, 22: banker side, 23: player side, 24: chip tray, 25: card read window, 26, cut-out portion, 30A, 30B: bet display, 31 to 40: chip bet area, 41, 42: card way, 43 to 45: bet spot, 46: area, 50: dealer display, 60: numeric keypad, 70: ruled line display, 71: primary ruled line representation, 72: secondary ruled line representation, 73: outcome representation, 74: scoreboard, 80: system control device, 81: a bet area display control unit, 82: a bet condition setting unit, 83: a card deal instruction control unit, 84: a competition history output unit, 85: a chronological record storing unit, 86: game rule storing unit, 87: deal rule storing unit, 90: input/output device, 91: history, 110: baccarat table system, 120: table, 121: competition progression area, 122: banker side, 123: player side, 125, card read window, 126: cut-out portion, 130, 131 to 137: bet display, 141: chip bet area, 141A: bet spot for player side, 141B: bet spot for banker side, 142 to 144: chip bet area, 144: chip display area, 145: chip image, 146: ruled line display zone, 147: optional game display zone, 148: chip balance, 150: dealer display, 160: numeric keypad, 170: announcement display, 171: representation, 172: score history, 180: system control device, 181: a bet area display control unit, 182: a bet condition setting unit, 183: a card deal instruction control unit, 184: a competition history output unit, 185: bet state display unit, 186: a chronological record storing unit, 187: a chip image display unit, 188: a chip image display changing unit, 189: a settling unit, 190, 191 to 197: mouse, 200: input/output device, 211: game rule storing unit, 212: deal rule storing unit, 220: card arrangement portion, 231: history, C, C1 to C10: game participant, D: dealer

What is claimed is:

1. A baccarat table system comprising a table presenting on an upper surface thereof a competition progression area in which a dealer deals cards to progress a competition between two imaginary persons and a chip bet area having a plurality of bet spots set for each of game participants and set up in association with types of expectations about the competition between the two persons, the game participants betting chips on the plurality of bet spots based on expectations of the game participants, wherein the system comprises:
a card type output unit configured to output a type of a card dealt by a dealer;
a bet display unit arranged to present a display screen on the upper surface of the table and configured to display the chip bet area for each of the game participants in a projected image;
a bet area display control unit configured to sequentially change a display state of the chip bet area in the bet display unit responsive to a deal state of cards based on the output from the card type output unit;
a competition history output unit configured to output a history of the competition based on the output from the card type output unit; and
a chronological record storing unit configured to store histories output by the competition history output unit chronologically and in a manner manageable in a ledger, wherein
the bet area display control unit can change a quantity and types of bet spots for expectations.

2. A baccarat table system comprising a table presenting on an upper surface thereof a competition progression area in which a dealer deals cards to progress a competition between two imaginary persons and a chip bet area having a plurality of bet spots set for each of game participants and set up in association with types of expectations about the competition between the two persons, the game participants betting chips on the plurality of bet spots based on expectations of the game participants, wherein the system comprises:
a card type output unit configured to output a type of a card dealt by a dealer;
a bet display unit arranged to present a display screen on the upper surface of the table and configured to display the chip bet area for each of the game participants in a projected image;
a bet area display control unit configured to change a display state of the chip bet area in the bet display unit responsive to a deal state of cards based on the output from the card type output unit;
a bet designating unit arranged for each of the game participants and configured to designate a chip amount and a bet spot on which chips are bet according to an instruction from that game participant;
a chip image display unit configured to display, in the designated bet spot in the chip bet area as a bet state, a chip image representing a chip bet in the bet display unit according to an instruction from the bet designating unit;
a settling unit configured to settle bet chips based on an outcome of the competition;
a competition history output unit configured to output a history of the competition based on the output from the card type output unit; and
a chronological record storing unit configured to store histories output by the competition history output unit chronologically and in a manner manageable in a ledger, wherein
the bet area display control unit can change a quantity and types of bet spots for expectations.

3. The baccarat table system according to claim 1, wherein the bet display unit is arranged to present a display screen on the upper surface of the table, and displays on each of one or more display devices the chip bet area for each of the game participants in a projected image with the chip bet areas displayed separately in association with the respective game participants.

4. The baccarat table system according to claim 2, comprising an announcement display configured to display statistic data including at least one of: data pertaining to a bet state and a hit or miss state of chips and a cumulative total of won chips in each game for each of the game participants; data in terms of current and previous shoes, previous dates and previous months that is aggregated for the table; and data pertaining to hitting rates and the maximum points won at a single betting for the game participants.

5. The baccarat table system according to claim 1, comprising:
a dealer display unit for the dealer to see; and
a card deal instruction control unit configured to cause the dealer display unit to display an instruction on dealing of cards based on the output from the card type output unit and in accordance with a baccarat rule.

6. The baccarat table system according to claim 2, comprising:
a dealer display unit for the dealer to see; and
a card deal instruction control unit configured to cause the dealer display unit to display an instruction on dealing of cards based on the output from the card type output unit and in accordance with a baccarat rule.

7. The baccarat table system according to claim 1, comprising a ruled line display unit configured to display a ruled line which is a history of the competition based on the history output by the competition history output unit.

8. The baccarat table system according to claim 2, comprising a ruled line display unit configured to display a ruled line which is a history of the competition based on the history output by the competition history output unit.

9. The baccarat table system according to claim 2, wherein:
the system comprises a bet condition setting unit configured to set an allowable upper limit amount for betting and hitting odds for each of the bet spots; and
the bet display unit displays the upper limit amount and the hitting odds.

10. The baccarat table system according to claim 1, wherein after a period of time during which betting is permitted elapses, the bet area display control unit displays, on the chip bet area, a representation indicating that the period of time during which betting is permitted elapsed.

11. The baccarat table system according to claim 2, wherein after a period of time during which betting is permitted elapses, the bet area display control unit displays, on the chip bet area, a representation indicating that the period of time during which betting is permitted elapsed.

12. The baccarat table system according to claim 1, wherein the bet area display control unit displays on bet spots that no longer have a possibility of being right during a progression of the competition, a representation indicating that the bet spots no longer have the possibility of being right.

13. The baccarat table system according to claim 1, wherein the bet area display control unit displays on bet spots that have been determined to be right during a progression of the competition, a representation indicating that the bet spots have been determined to be right.

14. The baccarat table system according to claim 2, comprising a bet amount adjusting unit configured to adjust bet amounts of all the game participants at a certain ratio when a difference between bet amount totals bet respectively on a player and a banker by the game participants exceeds a predetermined value set in advance, the difference being calculated based on bet states of all bet spots for the game participants, so that the difference does not go beyond the predetermined value.

15. The baccarat table system according to claim 1, comprising, on the table, a card travelling area for giving a card to the game participants that is located between the chip bet areas.

16. The baccarat table system according to claim 2, comprising:
a data accumulation unit configured to accumulate statistic data including at least one of: data pertaining to a bet state and a hit or miss state of chips and a cumulative total of won chips in each game for the game participants; data in terms of current and previous shoes, previous dates and previous months that is aggregated for the table; and data pertaining to hitting rates and the maximum points won at a single betting for the game participants;
a visualized data generating unit configured to output, as a visualized representation data, designated data from the data accumulated in the data accumulation unit; and
an information display unit configured to display an image based on the visualized representation data.

17. The baccarat table system according to claim 2, wherein when a bet amount limit is exceeded in any of the bet spots, the bet area display control unit prohibits betting on that bet spot, and after a period of time during which betting is permitted elapses, the bet area display control unit prohibits further betting on the chip bet area.
